(19) United States
(12) Patent Application Publication
(10) Pub. No.: US 2014/0161686 A1
(43) Pub. Date: Jun. 12, 2014

(54) SYSTEM AND METHOD OF DISPENSING LIQUIDS IN A MICROFLUIDIC DEVICE

(71) Applicant: Advanced Liquid Logic, Inc., Research Triangle Park, NC (US)

(72) Inventors: Donovan E. BORT, Apex, NC (US); Vijay SRINIVASAN, Durham, NC (US); Patrick STERLINA, Apex, NC (US); Uichong B. YI, Cary, NC (US); Justin CAPPELLETTI, East Greenwich, RI (US)

(73) Assignee: Advanced Liquid Logic, Inc., Research Triangle Park, NC (US)

(21) Appl. No.: 14/102,367

(22) Filed: Dec. 10, 2013

Related U.S. Application Data
(60) Provisional application No. 61/735,298, filed on Dec. 10, 2012.

(51) Int. Cl. B01L 3/00

(52) U.S. Cl. CPC B01L 3/527
USPC 422/502

(57) ABSTRACT

Microfluidic system including a droplet actuator having an interior cavity and a series of electrodes arranged along the interior cavity for forming a droplet-operation path therethrough. The droplet actuator has a module-engaging side including an opening that is in flow communication with the interior cavity. The microfluidic system also includes a reservoir module configured to be coupled to the droplet actuator. The reservoir module includes a plurality of liquid compartments having respective outlets and at least one seal positioned along the outlets to retain liquid within the liquid compartments. The reservoir module is movable along the module-engaging side of the droplet actuator to position the outlets relative to the opening. The microfluidic system also includes a piercer having a tip configured to penetrate the seal thereby permitting the liquid within the corresponding liquid compartment to flow into the opening.

### CROSS-REFERENCE TO RELATED APPLICATIONS

The present application claims the benefit of U.S. Provisional Application No. 61/735,298, filed on Dec. 10, 2012, which is hereby incorporated by reference in its entirety.

### GOVERNMENT INTEREST

This invention was made with government support under HHSN272200900030C awarded by the National Institutes of Health. The United States Government has certain rights in the invention.

### BACKGROUND

A droplet actuator typically includes one or more substrates configured to form a surface or gap for conducting droplet operations. The one or more substrates establish a droplet operations surface or gap for conducting droplet operations and may also include electrodes arranged to conduct the droplet operations. The droplet operations substrate or the gap between the substrates may be coated or filled with a filler fluid that is immiscible with the liquid that forms the droplets. Because of the small size of droplet actuators and the small and precise volumes of liquids that are used when performing assays, it can be difficult to load liquids into droplet actuators. Therefore, there is a need for new approaches to loading liquids into droplet actuators.

### BRIEF DESCRIPTION

In an embodiment, a microfluidic system is provided that includes a droplet actuator having an interior cavity and a series of electrodes arranged along the interior cavity for forming a droplet-operation path therethrough. The droplet actuator has a module-engaging side including an opening that is in flow communication with the interior cavity. The microfluidic system also includes a reservoir module configured to be coupled to the droplet actuator. The reservoir module includes a plurality of liquid compartments having respective outlets and at least one seal positioned along the outlets to retain liquid within the liquid compartments. The reservoir module is movable along the module-engaging side of the droplet actuator to position the outlets relative to the opening. The microfluidic system also includes a piercer having a tip configured to penetrate the seal thereby permitting the liquid within the corresponding liquid compartment to flow into the opening.

In an embodiment, a method of dispensing liquid is provided. The method includes providing a microfluidic device having an interior cavity and a module-engaging side. The module-engaging side has an opening that is in fluid communication with the interior cavity. The method also includes positioning a reservoir module along the module-engaging side of the microfluidic device. The reservoir module includes first and second liquid compartments having respective outlets and at least one seal positioned along the outlets to retain liquid within the first and second liquid compartments. The method also includes piercing the seal along the outlet of the first liquid compartment to permit the liquid from the first liquid compartment to flow through the opening of the microfluidic device. The method also includes sliding the reservoir module along the module-engaging side of the microfluidic device. The method also includes piercing the seal along the outlet of the second liquid compartment to permit the liquid from the second liquid compartment to flow through the opening of the microfluidic device.

In an embodiment, a reservoir module is provided that includes a module body having a mounting side configured to interface with a microfluidic device. The module body includes a plurality of liquid compartments that have corresponding liquids preloaded therein. The reservoir module also includes at least one seal extending along the mounting side and covering respective outlets of the liquid compartments. The liquids are separately stored within the corresponding liquid compartments. The seal is configured to be at least one of penetrated or ruptured to permit the liquids to exit the corresponding liquid compartments through the seal and the mounting side.

In an embodiment, a droplet actuator is provided that includes an actuator housing having an interior cavity and a series of electrodes arranged along the interior cavity for forming a droplet-operation path therethrough. The actuator housing has a module-engaging side including an opening that is in flow communication with the interior cavity. The droplet actuator also includes a piercing mechanism having a body that is coupled to the substrate and positioned within or proximate to the opening. The body of the piercing mechanism is configured to at least one of penetrate or rupture a seal of a reservoir along the module-engaging side of the substrate.

### BRIEF DESCRIPTION OF THE DRAWINGS

FIG. 1 illustrates a cross-sectional view of a portion of a droplet actuator that includes a piercer for piercing seals of on-actuator or off-actuator reservoirs of a droplet actuator;

FIGS. 2A, 2B, and 2C illustrate side views of an example of a piercer and a process of installing the piercer in, for example, the bottom substrate of a droplet actuator,

FIGS. 3 through 7 illustrate various views of other examples of piercers for use in a droplet actuator;

FIGS. 8 and 9 illustrate cross-sectional views of yet another example of a piercer in a droplet actuator and a process of adjusting the height of the droplet operations gap to pierce a seal;

FIG. 10 illustrates a cross-sectional view of the piercer of FIGS. 8 and 9 that further includes a fluid channel therein;

FIG. 11 illustrates a cross-sectional view of the piercer of FIGS. 8 and 9 that is electrified;

FIG. 12 illustrates a cross-sectional view of a portion of a droplet actuator that includes an off-actuator reservoir with a built-in piercer;

FIGS. 13 and 14 illustrate cross-sectional views of examples of pipette-style dispensers for loading liquid into a droplet actuator;

FIGS. 15 and 16 illustrate cross-sectional views (not to scale) of a portion of a droplet actuator 1400 that includes an electric wire for rupturing seals in a droplet actuator;

FIGS. 17 and 18 illustrate cross-sectional views of a portion of a droplet actuator and methods of using wax seals in the outlet of a reservoir;

FIG. 19 illustrates a cross-sectional view of a portion of a droplet actuator and a method of using silicone-oil-soluble wax for retaining lyophilized beads or encapsulated liquid reagent in the droplet operations gap;

FIGS. 20A and 20B illustrate top views and cross-sectional views of a portion of a droplet actuator that includes an off-actuator reservoir for metering a certain volume of liquid into the droplet actuator;

FIG. 21 illustrates an isometric view of a syringe whose outlet tip is designed for piercing the seal of a loading port of a droplet actuator;

FIGS. 22 and 23 illustrate cross-sectional views of a portion of a droplet actuator that includes a loading port that is designed to receive the syringe of FIG. 21 and a process of using the syringe;

FIG. 24 illustrates an isometric view of a syringe assembly that is based on the syringe and the loading port that are described with reference to FIGS. 21, 22, and 23;

FIGS. 25 and 26 illustrate cross-sectional views of the syringe assembly of FIG. 24;

FIGS. 27, 28, and 29 illustrate cross-sectional views of a portion of a droplet actuator that includes an off-actuator reservoir that has a bladder for controlling the amount of liquid dispensed therefrom;

FIG. 30 illustrates a top down view and a cross-sectional view of an example of a disposable storage module that includes a bladder;

FIGS. 31 through 38 illustrate various views of a dispensing system in combination with a droplet actuator, wherein the dispensing module uses bladders for dispensing fluids therefrom;

FIGS. 39 through 42 illustrate various views of a rotary dispensing system in combination with a droplet actuator;

FIG. 43 illustrates an isometric view of one example configuration of a reservoir module, which is the dispenser portion of the rotary dispensing module of FIGS. 39 through 42;

FIG. 44 illustrates cross-sectional views of other example configurations of the reservoir module, which is the dispenser portion of the rotary dispensing module of FIGS. 39 through 42;

FIGS. 45A, 45B, and 45C illustrate top down views of a bottom substrate, a top substrate, and a rotary dispensing module, respectively, that when assembled form the droplet actuator that is shown in FIG. 46;

FIG. 46 illustrates a cross-sectional view of a portion of a droplet actuator; wherein the droplet actuator includes the electrode arrangement of FIG. 45A, the reservoir arrangement of FIG. 45B, and the rotary dispensing module of FIG. 45C;

FIGS. 47A, 47B, and 47C illustrate top down views of another example of a rotary dispensing module;

FIG. 48 illustrates a cross-sectional view of a portion of a droplet actuator that includes a slidable dispensing reservoir; and

FIG. 49 illustrates a functional block diagram of an example of a microfluidics system that includes a droplet actuator.

### DESCRIPTION

As used herein, the following terms have the meanings indicated: “Activate,” with reference to one or more electrodes, means affecting a change in the electrical state of the one or more electrodes which, in the presence of a droplet, results in a droplet operation. Activation of an electrode can be accomplished using alternating or direct current. Any suitable voltage may be used. For example, an electrode may be activated using a voltage which is greater than about 150 V, or greater than about 200 V, or greater than about 250 V, or from about 275 V to about 1000 V, or about 300 V. Where alternating current is used, any suitable frequency may be employed. For example, an electrode may be activated using alternating current having a frequency from about 1 Hz to about 10 MHz, or from about 10 Hz to about 60 Hz, or from about 20 Hz to about 40 Hz, or about 30 Hz.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a flow path that permits a droplet including the beads to be brought into a droplet operations gap or into contact with a droplet operations surface. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead, a portion of a bead, or only one component of a bead. The remainder of the bead may include, among other things, polymeric material, coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication Nos. 20050260686, entitled “Multiplex flow assays preferably with magnetic particles as solid phase,” published on Nov. 24, 2005; 20030132538, entitled “Encapsulation of discrete quanta of fluorescent particles,” published on Jul. 17, 2003; 20050118574, entitled “Multiplexed Analysis of Clinical Specimens Apparatus and Method,” published on Jun. 2, 2005; 20050277197. Entitled “Microparticles with Multiple Fluorescent Signals and Methods of Using Same,” published on Dec. 15, 2005; 20060159962, entitled “Magnetic Microspheres for use in Fluorescence-based Applications,” published on Jul. 20, 2006; the entire disclosures of which are incorporated herein by reference for their teaching concerning beads and magnetically responsive materials and beads. Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference. Bead characteristics may be employed in the multiplexing aspects of the invention. Examples of beads having characteristics suitable for multiplexing, as well as methods of detecting and analyzing signals emitted from such beads, may be found in U.S. Patent Publication No. 20080305481, entitled “Systems and Methods for Multiplex Analysis of PCR in Real Time,” published on Dec. 11, 2008; U.S. Patent Publication No. 20080151240, “Methods and Systems for Dynamic Range Expansion,” published on Jun. 26, 2008; U.S. Patent Publication No. 20070207513, entitled “Methods, Products, and Kits for Identifying an Analyte in a Sample,” published on Sep. 6, 2007; U.S. Patent Publication No. 20070064990, entitled “Methods and Systems for Image Data Processing,” published on Mar. 22, 2007; U.S. Patent Publication No. 20060159962, entitled “Magnetic Microspheres for use in Fluorescence-based Applications,” published on Jul. 20, 2006; U.S. Patent Publication No. 20050277197, entitled “Microparticles with Multiple Fluorescent Signals and Methods of Using Same,” published on Dec. 15, 2005; and U.S. Patent Publication No. 20050118574, entitled “Multiplexed Analysis of Clinical Specimens Apparatus and Method,” published on Jun. 2, 2005.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), other fluorinated monomers for plasma-enhanced chemical vapor deposition (PECVD), and organosiloxane (e.g., SiOC) for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene)poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester, polyethylene naphthalate; polycarbonate; polyetheretherketone; liquid crystal polymer, cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass), PARYLENE™ N, and PARYLENE™ HT (for high temperature, ˜300° C.) (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; and polypropylene. Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., International Patent Pub. No. WO/2008/101194, entitled “Capacitance Detection in a Droplet Actuator,” published on Aug. 21, 2008, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1×-, 2×- 3×-droplets are usefully controlled operated using 1, 2, and 3 electrodes, respectively. If the droplet footprint is greater than the number of electrodes available for conducting a droplet operation at a given time, the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be or include a low-viscosity oil, such as silicone oil or hexadecane filler fluid. The filler fluid may be or include a halogenated oil, such as a fluorinated or perfluorinated oil. The filler fluid may fill the entire gap of the droplet actuator or may coat one or more surfaces of the droplet actuator. Filler fluids may be conductive or non-conductive. Filler fluids may be selected to improve droplet operations and/or reduce loss of reagent or target substances from droplets, improve formation of microdroplets, reduce cross contamination between droplets, reduce contamination of droplet actuator surfaces, reduce degradation of droplet actuator materials, etc. For example, filler fluids may be selected for compatibility with droplet actuator materials. As an example, fluorinated filler fluids may be usefully employed with fluorinated surface coatings. Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in U.S. Patent Pub. No. 20110118132, published on May 19, 2011, the entire disclosure of which is incorporated herein by reference. Examples of suitable fluorinated oils include those in the Galden line, such as Galden HT170 (bp=170° C., viscosity=1.8 cSt, density=1.77), Galden HT200 (bp=200 C, viscosity=2.4 cSt, d=1.79), Galden HT230 (bp=230 C, viscosity=4.4 cSt, d=1.82) (all from Solvay Solexis); those in the Novec line, such as Novec 7500 (bp=128 C, viscosity=0.8 cSt, d=1.61), Fluorinert FC-40 (bp=155° C., viscosity=1.8 cSt, d=1.85), Fluorinert FC-43 (bp=174° C., viscosity=2.5 cSt, d=1.86) (both from 3M). In general, selection of perfluorinated filler fluids is based on kinematic viscosity (<7 cSt is preferred, but not required), and on boiling point (>150° C. is preferred, but not required, for use in DNA/RNA-based applications (PCR, etc.)). Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al., International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein. Fluorinated oils may in some cases be doped with fluorinated surfactants, e.g., Zonyl FSO-100 (Sigma-Aldrich) and/or others.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe3O4, BaFe12O19, CoO, NiO, Mn2O3, Cr2O3, and CoMnP.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Transporting into the magnetic field of a magnet,” “transporting towards a magnet,” and the like, as used herein to refer to droplets and/or magnetically responsive beads within droplets, is intended to refer to transporting into a region of a magnetic field capable of substantially attracting magnetically responsive beads in the droplet. Similarly, “transporting away from a magnet or magnetic field,” “transporting out of the magnetic field of a magnet,” and the like, as used herein to refer to droplets and/or magnetically responsive beads within droplets, is intended to refer to transporting away from a region of a magnetic field capable of substantially attracting magnetically responsive beads in the droplet, whether or not the droplet or magnetically responsive beads is completely removed from the magnetic field. It will be appreciated that in any of such cases described herein, the droplet may be transported towards or away from the desired region of the magnetic field, and/or the desired region of the magnetic field may be moved towards or away from the droplet. Reference to an electrode, a droplet, or magnetically responsive beads being “within” or “in” a magnetic field, or the like, is intended to describe a situation in which the electrode is situated in a manner which permits the electrode to transport a droplet into and/or away from a desired region of a magnetic field, or the droplet or magnetically responsive beads is/are situated in a desired region of the magnetic field, in each case where the magnetic field in the desired region is capable of substantially attracting any magnetically responsive beads in the droplet. Similarly, reference to an electrode, a droplet, or magnetically responsive beads being “outside of” or “away from” a magnetic field, and the like, is intended to describe a situation in which the electrode is situated in a manner which permits the electrode to transport a droplet away from a certain region of a magnetic field, or the droplet or magnetically responsive beads is/are situated away from a certain region of the magnetic field, in each case where the magnetic field in such region is not capable of substantially attracting any magnetically responsive beads in the droplet or in which any remaining attraction does not eliminate the effectiveness of droplet operations conducted in the region. In various aspects of the invention, a system, a droplet actuator, or another component of a system may include a magnet, such as one or more permanent magnets (e.g., a single cylindrical or bar magnet or an array of such magnets, such as a Halbach array) or an electromagnet or array of electromagnets, to form a magnetic field for interacting with magnetically responsive beads or other components on chip. Such interactions may, for example, include substantially immobilizing or restraining movement or flow of magnetically responsive beads during storage or in a droplet during a droplet operation or pulling magnetically responsive beads out of a droplet.

“Washing” with respect to washing a bead means reducing the amount and/or concentration of one or more substances in contact with the bead or exposed to the bead from a droplet in contact with the bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

The invention is mechanisms for and methods of dispensing liquids in a droplet actuator. For example, various types of reservoirs for use with droplet actuators are disclosed, wherein the reservoirs are preloaded with, for example, sample fluid, liquid reagent, or filler fluid and sealed. In some embodiments, the preloaded reservoir is integrated directly into, for example, the top substrate of the droplet actuator. In other embodiments, the preloaded reservoir is a separate and disposable component with respect to the droplet actuator that can be mechanically and fluidly coupled to the droplet actuator.

Additionally, various types of piercing mechanisms are disclosed for rupturing the seals of the preloaded reservoirs, wherein rupturing the seals causes the liquid to be dispensed into the droplet actuator. In some embodiments, the piercing mechanism is integrated directly into the droplet actuator. Namely, a piercing mechanism is provided in the droplet operations gap of the droplet actuator or protruding from the top substrate. In other embodiments, the piercing mechanism is integrated into the preloaded reservoir, which may be a separate and disposable component with respect to the droplet actuator.

Further, dispensing mechanisms are disclosed for precisely metering the amount of liquid that is dispensed into the droplet actuator. For example, dispensing mechanisms include bladders and weirs for controlling the amount of liquid that is dispensed.

Further, dispensing mechanisms and systems are disclosed that include multiple preloaded reservoirs and mechanisms for rupturing the seals of the multiple preloaded reservoirs. For example, rotatable dispenser systems are disclosed that include multiple preloaded reservoirs and mechanisms for rupturing the seals thereof.

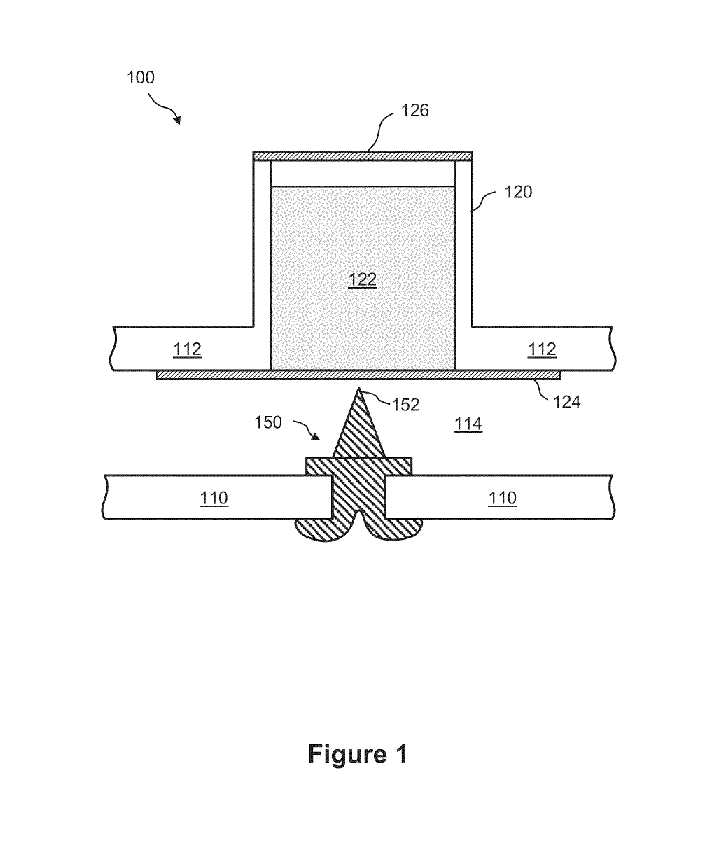

FIG. 1 illustrates a cross-sectional view (not to scale) of a portion of a droplet actuator 100 that includes a piercer 150 for piercing seals of on-actuator or off-actuator reservoirs of a droplet actuator, such as, for example, droplet actuator 100. Droplet actuator 100 includes a bottom substrate 110 and a top substrate 112 that are separated by a droplet operations gap 114. Droplet operations gap 114 contains filler fluid (not shown). The filler fluid is, for example, low-viscosity oil, such as silicone oil or hexadecane filler fluid.

A reservoir 120 is integrated into top substrate 112 for holding a quantity of liquid 122. Liquid 122 is, for example, sample fluid or liquid reagent. A seal 124 is provided at the outlet of reservoir 120, which is facing droplet operations gap 114 of droplet actuator 100. Similarly, a seal 126 is provided at the inlet of reservoir 120. Seal 124 and seal 126 are used to retain liquid 122 inside of reservoir 120 until liquid 122 is ready for use. Seal 124 and seal 126 are, for example, foil seals or cellophane seals. Optionally, reservoir 120 can be vacuum-sealed.

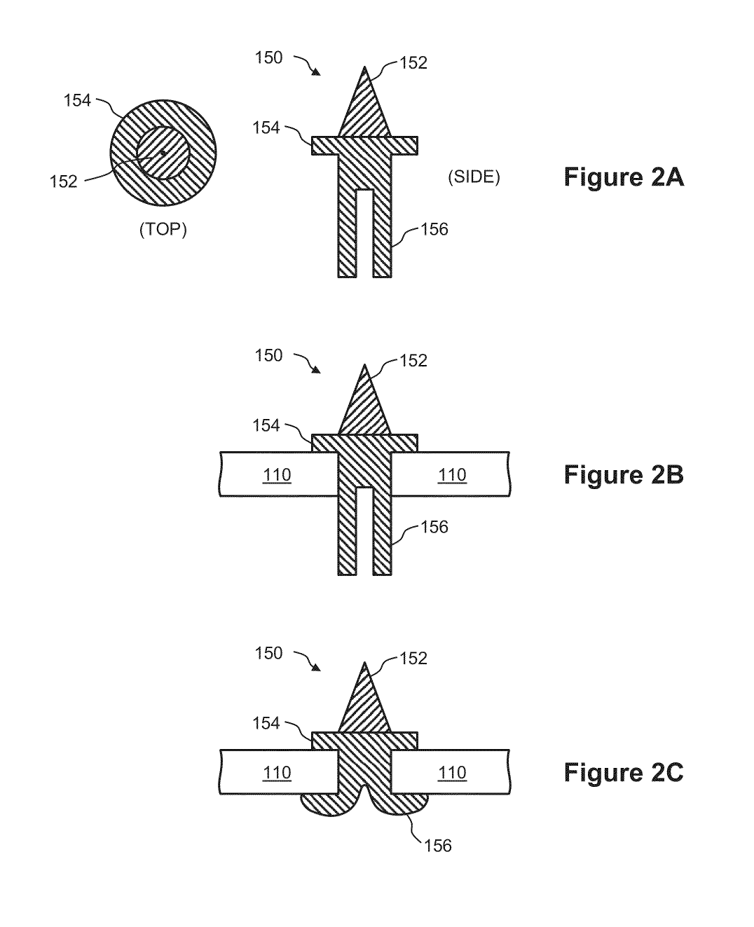

Piercer 150 is installed through an opening in bottom substrate 110. More details of an example of how piercer 150 is formed and installed are described with reference to FIGS. 2A, 2B, and 2C. A pointed tip 152 of piercer 150 is disposed in droplet operations gap 114 and in close proximity to seal 124 at the outlet of reservoir 120. The gap height setting features (not shown) of droplet actuator 100 are positioned suitable far from piercer 150 to allow bottom substrate 110 and/or top substrate 112 to be slightly flexed when pressure is applied to bottom substrate 110, top substrate 112, or both. Namely, in order to dispense liquid 122 from reservoir 120 into droplet operations gap 114, a user of droplet actuator 100 may squeeze bottom substrate 110 and top substrate 112 slightly together, which causes pointed tip 152 of piercer 150 to come into contact with and pierce (or puncture) seal 124 of reservoir 120. Once seal 124 is punctured, the user may stop squeezing the bottom substrate 110 and top substrate 112. Because seal 124 has been punctured, liquid 122 flows out of reservoir 120 and into droplet operations gap 114. The user may also puncture seal 126 at the inlet of reservoir 120 in order to vent reservoir 120, which will assist the flow of liquid 122 out of reservoir 120 and into droplet operations gap 114.

FIG. 2A illustrates a top and side view (not to scale) of piercer 150 that includes pointed tip 152, a mounting plate 154, and a split portion 156. Piercer 150 is formed, for example, of molded plastic. In one example, mounting plate 154 has a circular footprint and pointed tip 152 is cone-shaped. However, other shapes are possible. For example, mounting plate 154 may have a square, rectangular, or diamond footprint and pointed tip 152 may be pyramid-shaped. The split portion 156 of piercer 150 may begin as a solid shaft at mounting plate 154 and then splint into two tines as shown.

FIGS. 2B and 2C illustrate a process of installing piercer 150 in, for example, bottom substrate 110 of droplet actuator 100 of FIG. 1. For example, FIG. 2B shows that split portion 156 of piercer 150 is fitted through an opening in bottom substrate 110 such that mounting plate 154 is against one surface of bottom substrate 110. That is, mounting plate 154 acts as a “stop” when installing piercer 150 into bottom substrate 110. Referring now to FIG. 2C, once piercer 150 is fitted through the opening in bottom substrate 110, split portion 156 is heated with, for example, a heat stick mechanism. In so doing, the two tines in split portion 156 can be melted and then folded over (in opposite directions) against bottom substrate 110. In this manner, mounting plate 154 of piercer 150 is secured against one side of bottom substrate 110 while the deformed tines in split portion 156 of piercer 150 are secured against the other side of bottom substrate 110.

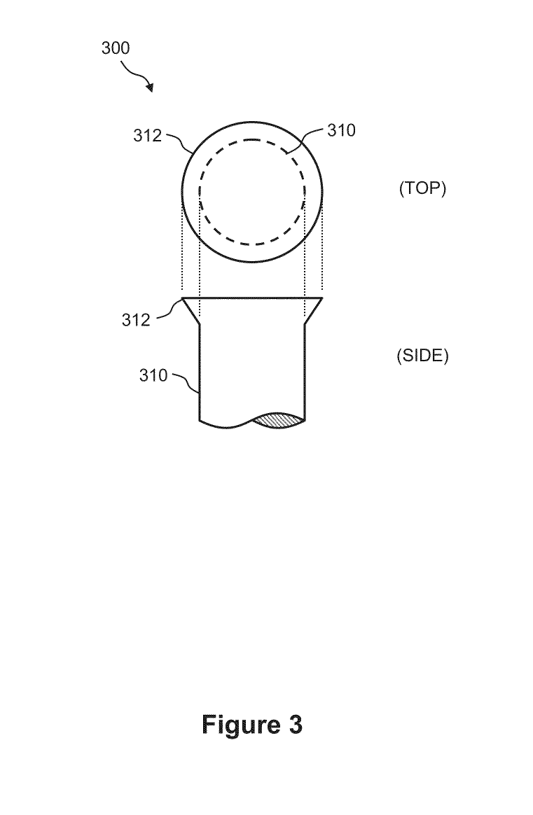

Piercer 150, and in particular pointed tip 152, can be any shape, geometry, or length as long as it provides a piercing mechanism. FIGS. 3 through 7 illustrate various views (not to scale) of other examples of piercers for use in a droplet actuator.

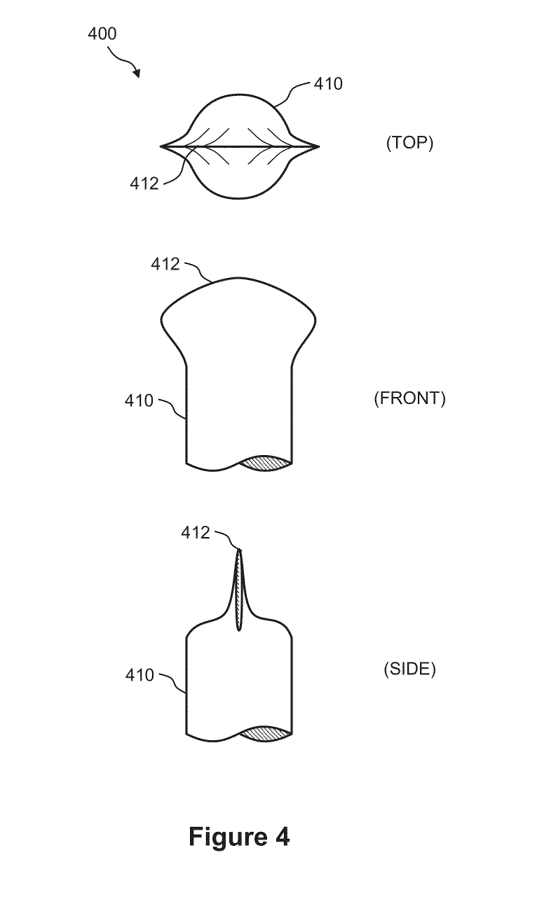

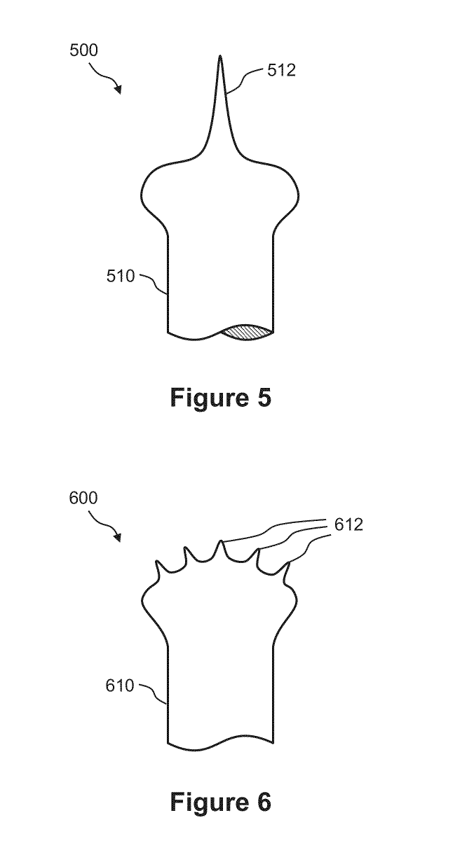

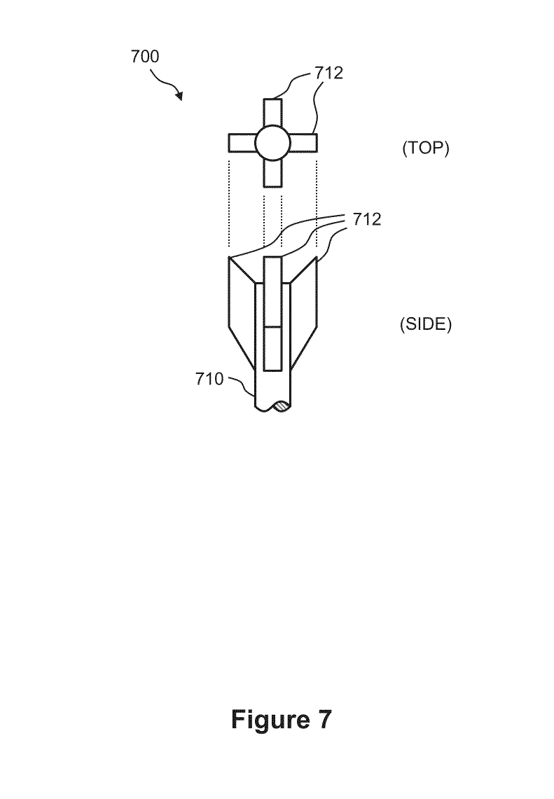

FIG. 3 shows a top and side view of a piercer 300. Piercer 300 includes a shaft 310. One end of shaft 310 has a sharp ridge or brim 312 that can be used for piercing or puncturing, for example, a foil seal or cellophane seal. FIG. 4 shows a top, front, and side view of a piercer 400. Piercer 400 includes a shaft 410. One end of shaft 410 has a blade 412 that can be used for piercing or puncturing, for example, a foil seal or cellophane seal. FIG. 5 shows a side view of a piercer 500. Piercer 500 includes a shaft 510. One end of shaft 510 has a spike 512 that can be used for piercing or puncturing, for example, a foil seal or cellophane seal. FIG. 6 shows a side view of a piercer 600. Piercer 600 includes a shaft 610. One end of shaft 610 has multiple spikes 612 that can be used for piercing or puncturing, for example, a foil seal or cellophane seal. FIG. 7 shows a side view of a piercer 700. Piercer 700 includes a shaft 710. One end of shaft 710 has multiple piercers 712 that can be used for piercing or puncturing, for example, a foil seal or cellophane seal. Namely, four piercers 712 of piercer 700 are arranged in a cross pattern, as shown. The invention is not limited to the piercers shown in FIGS. 1 through 7. Other piercer designs for use in or with droplet actuators are possible depending on the application.

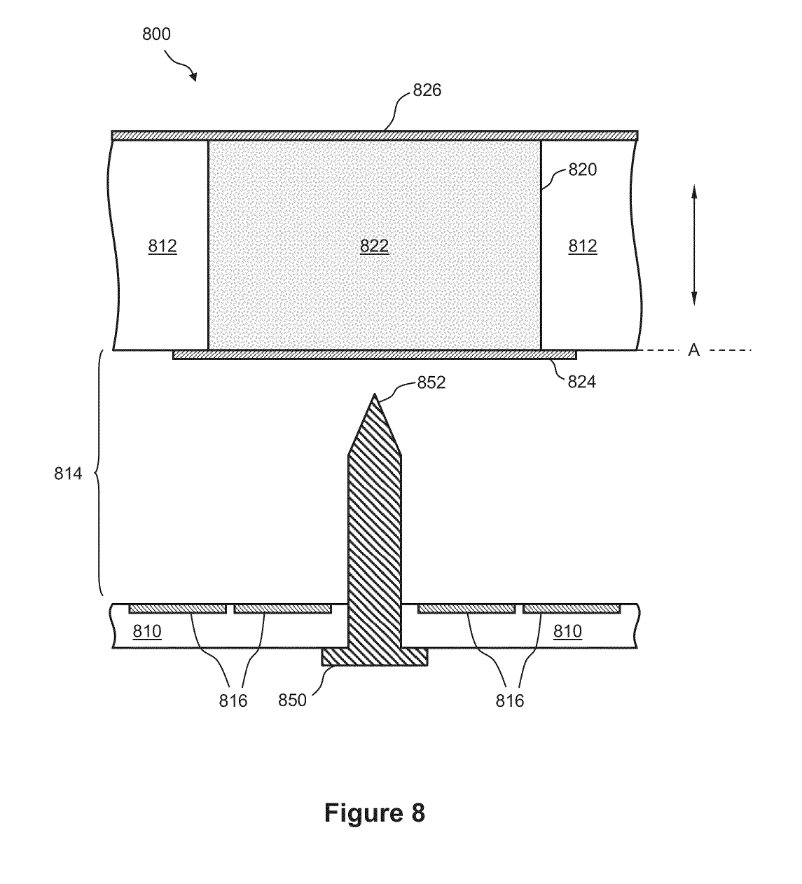

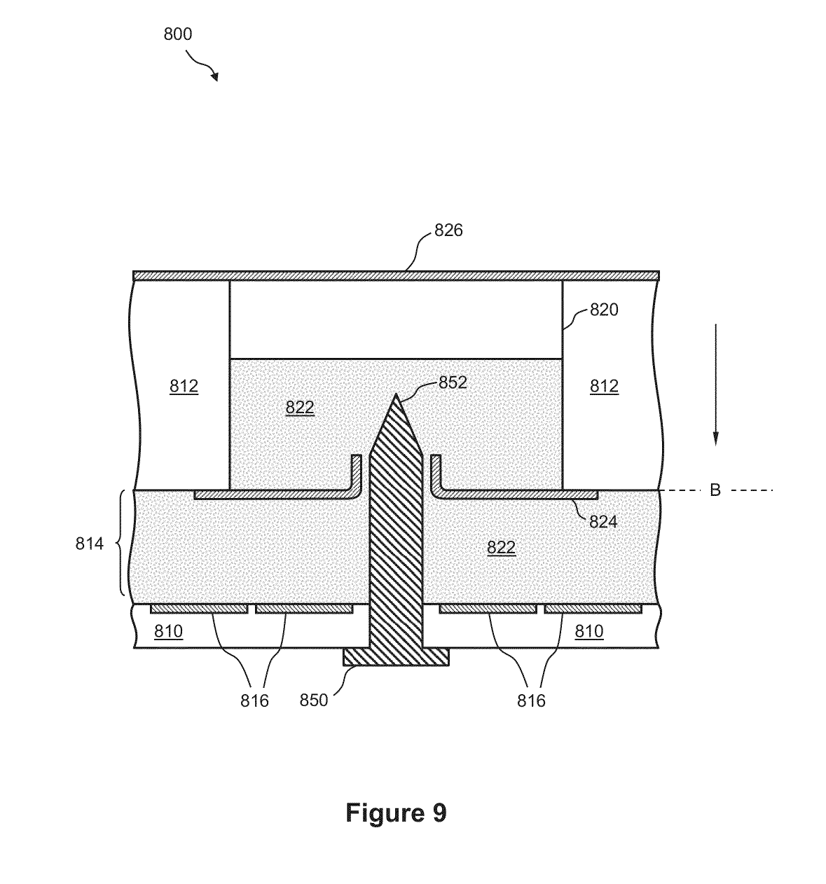

FIGS. 8 and 9 illustrate cross-sectional views (not to scale) of yet another example of a piercer in a droplet actuator 800 and a process of adjusting the height of the droplet operations gap to pierce a seal. Droplet actuator 800 includes a bottom substrate 810 and a top substrate 812 that are separated by a droplet operations gap 814. Bottom substrate 810 may include an arrangement of droplet operations electrodes 816 (e.g., electrowetting electrodes). Droplet operations are conducted atop droplet operations electrodes 816 on a droplet operations surface.

A reservoir 820 is integrated into top substrate 812 for holding a volume of liquid 822. Liquid 822 is, for example, sample fluid, liquid reagent, or filler fluid. A seal 824 is provided at the outlet of reservoir 820, which is facing droplet operations gap 814 of droplet actuator 800. Similarly, a seal 826 is provided at the inlet of reservoir 820. Seal 824 and seal 826 are used to retain liquid 822 inside of reservoir 820 until liquid 822 is ready for use. Seal 824 and seal 826 are, for example, foil seals or cellophane seals. Optionally, reservoir 820 can be vacuum-sealed. A piercer 850 is installed in bottom substrate 810. A pointed tip 852 of piercer 850 is disposed in droplet operations gap 814 and in close proximity to seal 824 at the outlet of reservoir 820. In one example, piercer 850 is formed of molded plastic. Additionally, the surface of piercer 850 is hydrophilic. Namely, the surface of piercer 850 has a hydrophilic coating (not shown) thereon. Examples of hydrophilic coatings are HYDAK® hydrophilic coatings available from Biocoat, Inc (Horsham, Pa.).

FIG. 8 shows top substrate 812 in a position A with respect to bottom substrate 810. In position A, the height of droplet operations gap 814 is larger than the length of piercer 850. Therefore, in position A the pointed tip 852 of piercer 850 is not in contact with seal 824 of reservoir 820 and seal 824 is not punctured. In order for piercer 850 to puncture seal 824, the height of droplet operations gap 814 must be less than the length of piercer 850, as shown in FIG. 9. Namely, FIG. 9 shows top substrate 812 in a position B with respect to bottom substrate 810. In position B, the height of droplet operations gap 814 is less than the length of piercer 850. Therefore, in position B the pointed tip 852 of piercer 850 is in contact with seal 824 of reservoir 820 and seal 824 is punctured. Once seal 824 is punctured, liquid 822 is dispensed from reservoir 820 into droplet operations gap 814 of droplet actuator 800. Namely, liquid 822 will flow through the puncture in seal 824, which is around the pointed tip 852 of piercer 850. The flow is, for example by capillary forces and gravity. Further, the flow of liquid 822 out of reservoir 820 and into droplet operations gap 814 is assisted by the hydrophilic surface of piercer 850.

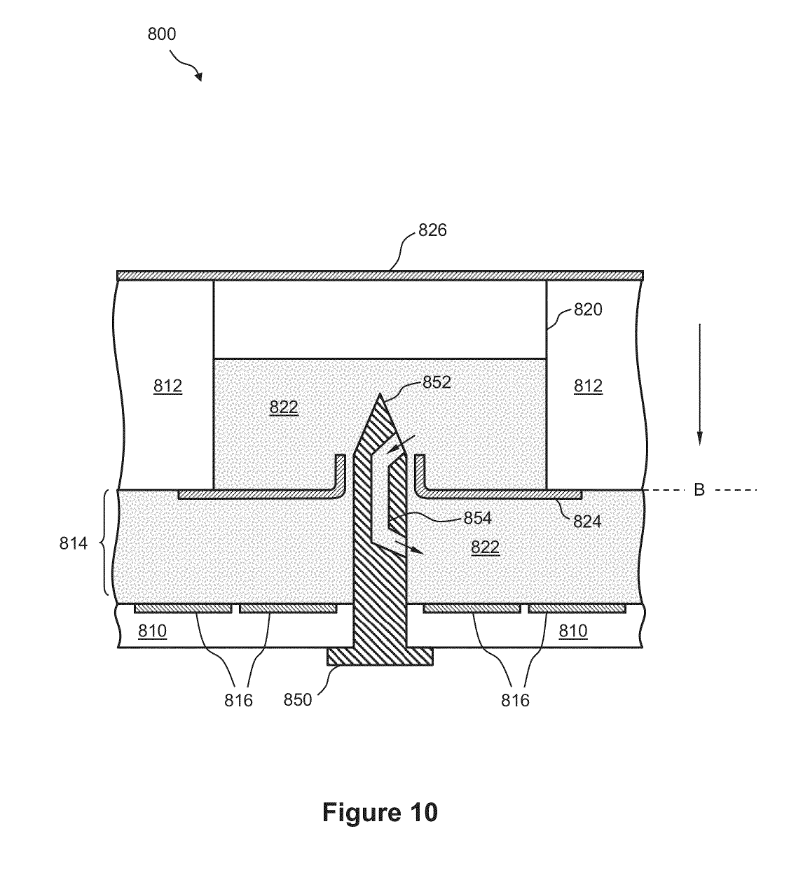

FIG. 10 illustrates a cross-sectional view of piercer 850 of FIGS. 8 and 9 that further includes a fluid channel therein. FIG. 10 shows droplet actuator 800 with top substrate 812 in a position B with respect to bottom substrate 810. When seal 824 is punctured using piercer 850, liquid 822 not only flows around the pointed tip 852 of piercer 850 but also through a fluid channel 854 in piercer 850. Namely, liquid 822 enters one end of fluid channel 854 that is inside reservoir 820 and exits the other end of fluid channel 854 that is inside droplet operations gap 814. The presence of fluid channel 854 in piercer 850 provides a higher flow rate of liquid 822 from reservoir 820 than a piercer 850 that does not include fluid channel 854. Additionally, this example of piercer 850 that includes fluid channel 854 supports non-capillary flow.

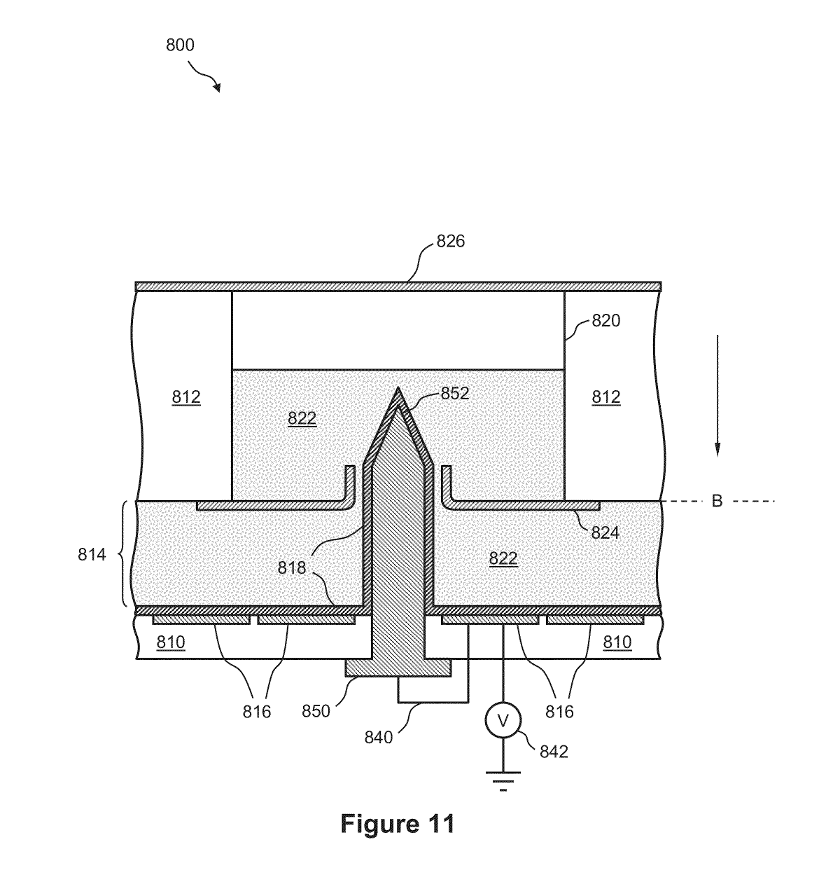

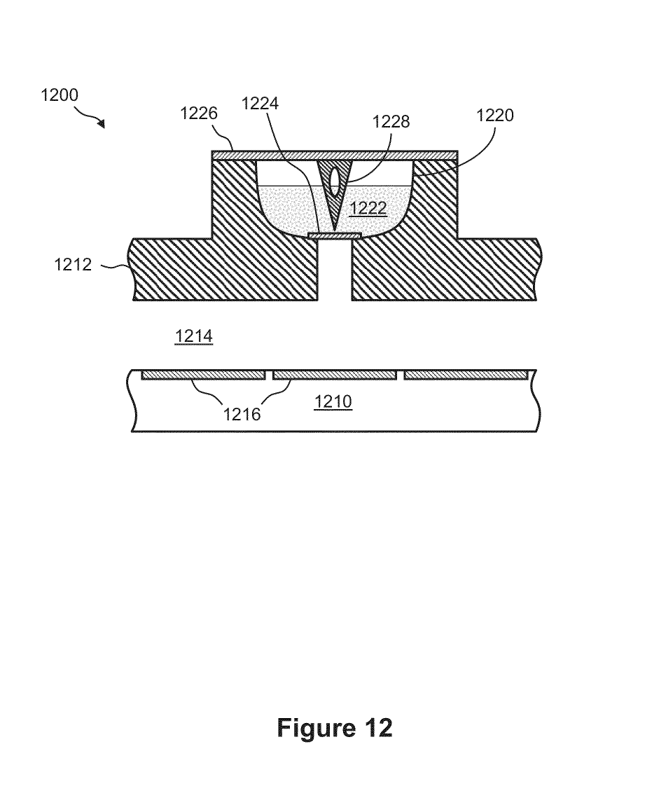

FIG. 11 illustrates a cross-sectional view of piercer 850 of FIGS. 8 and 9 that is electrified. FIG. 11 shows droplet actuator 800 with top substrate 812 in a position B with respect to bottom substrate 810. In this example, piercer 850 is formed of an electrically conductive material, such as gold, aluminum, silver, copper, and the like. Optionally, the droplet operations surface of bottom substrate 110 as well as the surface of piercer 850 has a hydrophobic coating 818. Hydrophobic coating 818 is, for example, from the FLUOROPEL® family of hydrophobic and superhydrophobic coatings available from Cytonix Corporation, Beltsville, Md.

In one example, an electrical connection 840 is provided between the electrically conductive piercer 850 and one of the droplet operations electrodes 816. A voltage source 842 supplies the droplet operations electrode 816 and therefore supplies piercer 850. Namely, by activating the voltage source 842 of the droplet operations electrode 816, both the droplet operations electrode 816 and the electrically conductive piercer 850 are activated. Optionally, the electrically conductive piercer 850 can be split into two or more electrically isolated and individually controlled components.

In operation, at substantially the same time as or just after the seal 824 is punctured using piercer 850, the electrically conductive piercer 850 is activated. The electrowetting forces that are present due to the electrified piercer 850 assist to pull liquid 822 out of reservoir 820 and into droplet operations gap 814. The presence of electrowetting forces due to the electrified piercer 850 provides a higher flow rate of liquid 822 from reservoir 820 than a piercer 850 that is not electrified.

FIG. 12 illustrates a cross-sectional view (not to scale) of a portion of a droplet actuator 1200 that includes an off-actuator reservoir with a built-in piercer. Droplet actuator 1200 includes a bottom substrate 1210 and a top substrate 1212 that are separated by a droplet operations gap 1214. Bottom substrate 1210 may include an arrangement of droplet operations electrodes 1216 (e.g., electrowetting electrodes). Droplet operations are conducted atop droplet operations electrodes 1216 on a droplet operations surface.

An off-actuator reservoir 1220 is integrated into top substrate 1212 for holding a quantity of liquid 1222. Liquid 1222 is, for example, sample fluid, liquid reagent, or filler fluid. Off-actuator reservoir 1220 is provided to supply liquid 1222 into the droplet operations gap 1214 of droplet actuator 1200. Off-actuator reservoir 1220 is, for example, a bowl-shaped reservoir. Off-actuator reservoir 1220 is sealed until liquid 1222 is ready for use. For example, an outlet of off-actuator reservoir 1220 has a seal 1224 and an inlet of off-actuator reservoir 1220 has a seal 1226. Seal 1224 at the outlet is, for example, a foil seal or cellophane seal. Seal 1226 at the inlet of off-actuator reservoir 1220 is, for example, a versapor oleophobic membrane, or the combination of a versapor oleophobic membrane and foil. If the latter, seal 1226 must include a small portion that is absent foil so that off-actuator reservoir 1220 can vent through versapor oleophobic membrane, which is porous, when liquid 1222 is dispensed therefrom.

A piercer 1228 is affixed to seal 1226 on the side of seal 1226 that is facing liquid 1222. Piercer 1228 has a pointed tip for puncturing seal 1224 at the outlet of off-actuator reservoir 1220. The length of piercer 1228 is such that when seal 1226 is tautly stretched across off-actuator reservoir 1220 the pointed tip of piercer 1228 is not in contact with seal 1224 and therefore does not puncture seal 1224. However, to dispense liquid 1222 the droplet operations gap 1214, the user applies gentle pressure to seal 1226, which causes seal 1226 to flex slightly toward the droplet operations gap 1214. In so doing, the pointed tip of piercer 1228 comes into contact with seal 1224 and punctures seal 1224, which allows liquid 1222 to flow out of the outlet and into the droplet operations gap 1214 of droplet actuator 1200. Off-actuator reservoir 1220 vents through the versapor oleophobic membrane of seal 1226, which is porous, as liquid 1222 dispenses therefrom.

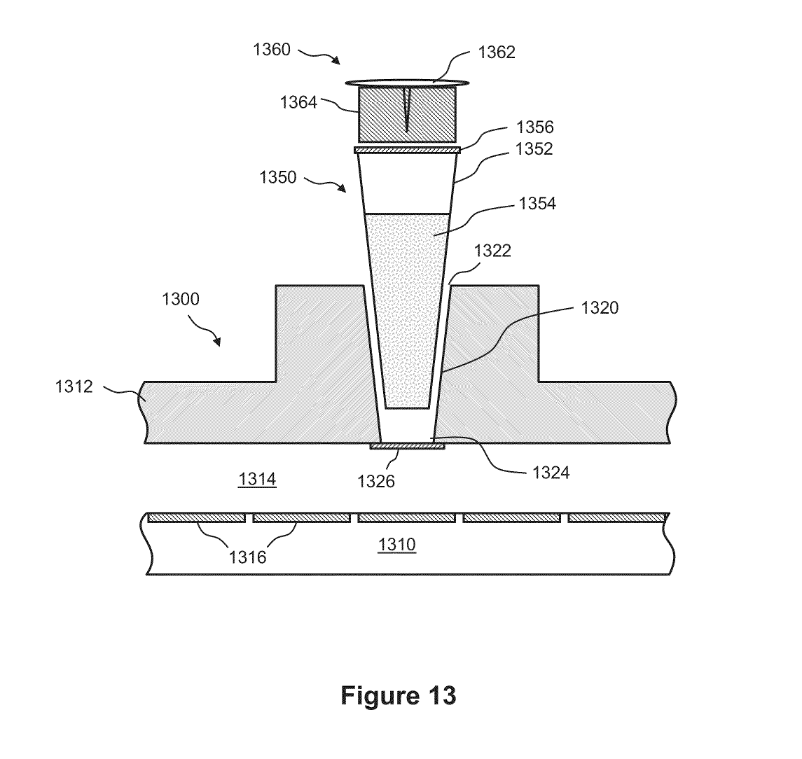

FIG. 13 illustrates a cross-sectional view (not to scale) of a pipette-style dispenser 1350, which is one example of a pipette-style dispenser, for loading liquid into a droplet actuator 1300. Droplet actuator 1300 includes a bottom substrate 1310 and a top substrate 1312 that are separated by a droplet operations gap 1314. Bottom substrate 1310 may include an arrangement of droplet operations electrodes 1316 (e.g., electrowetting electrodes). Droplet operations are conducted atop droplet operations electrodes 1316 on a droplet operations surface.

Pipette-style dispenser 1350 includes a barrel 1352 for holding a quantity of liquid 1354. Liquid 1354 is, for example, sample fluid, liquid reagent, or filler fluid. Barrel 1352 is a tapered barrel, meaning that an inlet of barrel 1352 has a larger diameter than an outlet of barrel 1352. A seal (not shown) at the outlet of barrel 1352 and a seal 1356 at the inlet of barrel 1352 are used to retain liquid 1354 inside of pipette-style dispenser 1350 until liquid 1354 is ready for use. The seal (not shown) at the outlet of barrel 1352 and seal 1356 are, for example, foil seals or cellophane seals. In another example, a removable cap is provided at the outlet of barrel 1352 instead of a seal. Optionally, pipette-style dispenser 1350 can be vacuum-sealed. A piercing mechanism 1360 is associated with pipette-style dispenser 1350. Piercing mechanism 1360 includes, for example, a thumbtack-style piercer 1362 that is embedded in a compressible material 1364. Compressible material 1364 is, for example, silicone rubber or foam. When compressible material 1364 is in a relaxed state the pointed tip of thumbtack-style piercer 1362 is hidden inside of compressible material 1364.

A loading port 1320 is integrated into top substrate 1312 for loading liquid into the droplet operations gap 1314 of droplet actuator 1300. Further, loading port 1320 is designed to receive pipette-style dispenser 1350. A port is an entrance/exit (opening) to the droplet operations gap of a droplet actuator. Liquid may flow through the port into and/or from any portion of the droplet operations gap. In droplet actuator 1300, loading port 1320 provides a fluid path through top substrate 1312 to the droplet operations gap 1314 between bottom substrate 1310 and top substrate 1312. In this example, loading port 1320 is tapered to receive pipette-style dispenser 1350. Namely, an inlet 1322 of loading port 1320 has a larger diameter than an outlet 1324 of loading port 1320. The taper of loading port 1320 substantially corresponds to the taper of barrel 1352 of pipette-style dispenser 1350. A seal 1326 is provided at outlet 1324 of loading port 1320. Seal 1326 is, for example, a foil seal or cellophane seal. The position of seal 1326 is such that it is at the same level as the filler fluid (not shown) in droplet operations gap 1314 and therefore air is not trapped near outlet 1324 of loading port 1320.

The operation of pipette-style dispenser 1350 for loading liquid 1354 into droplet actuator 1300 is as follows. First, the user removes the seal (not shown) at the outlet of barrel 1352 of pipette-style dispenser 1350. Because seal 1356 at the inlet of barrel 1352 is still intact, pipette-style dispenser 1350 is not vented and therefore liquid 1354 will not flow out of the outlet of barrel 1352. Next, the user seats the barrel 1352 of pipette-style dispenser 1350 into loading port 1320 of droplet actuator 1300. In so doing, the tip of barrel 1352 breaks seal 1326 of loading port 1320, thereby readying droplet actuator 1300 to receive liquid 1354. Next, the user places piercing mechanism 1360 against seal 1356 at the inlet of barrel 1352 of pipette-style dispenser 1350. Next, the user applies force to thumbtack-style piercer 1362 of piercing mechanism 1360, which compresses compressible material 1364. In so doing, the pointed tip of thumbtack-style piercer 1362 extended out of compressible material 1364 and pierces or punctures seal 1356 of pipette-style dispenser 1350. Next, the user removes piercing mechanism 1360 from pipette-style dispenser 1350, which allows pipette-style dispenser 1350 to vent. Having vented pipette-style dispenser 1350, liquid 1354 flows out of pipette-style dispenser 1350 and into the droplet operations gap 1314 of droplet actuator 1300. The design of loading port 1320 is such that air (if present in the droplet operations gap 1314) can vent out between the walls of loading port 1320 and pipette-style dispenser 1350 while liquid 1354 is flowing into the droplet operations gap 1314. Once pipette-style dispenser 1350 is empty of liquid 1354, the user may remove pipette-style dispenser 1350 from loading port 1320 of droplet actuator 1300. The empty pipette-style dispenser 1350 can be discarded or reloaded with liquid 1354 and resealed for another use.

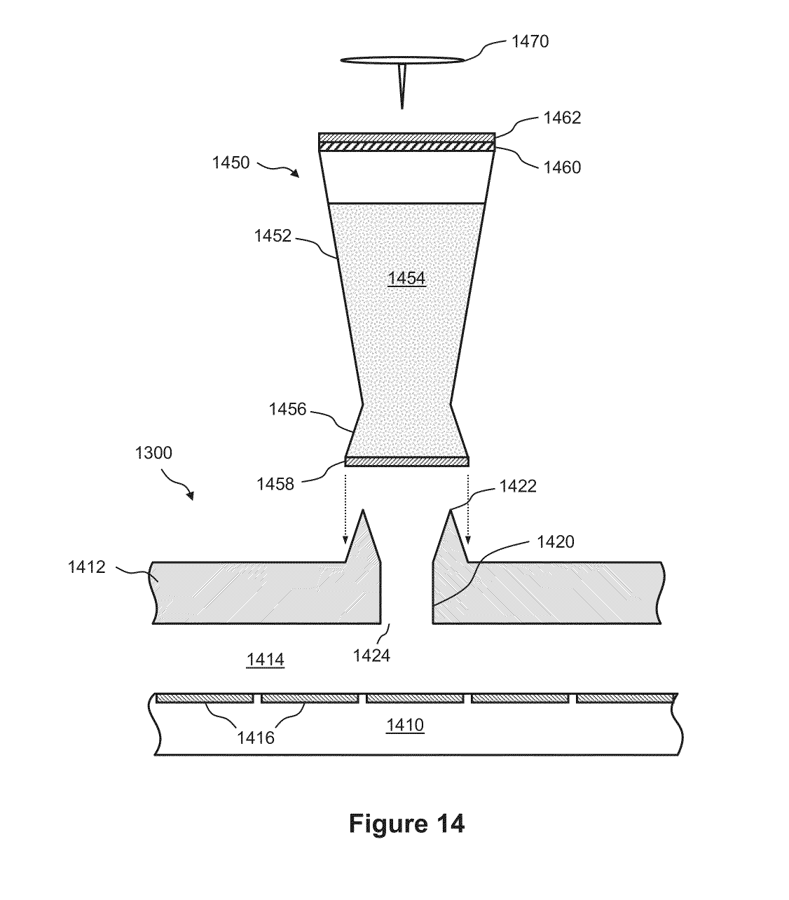

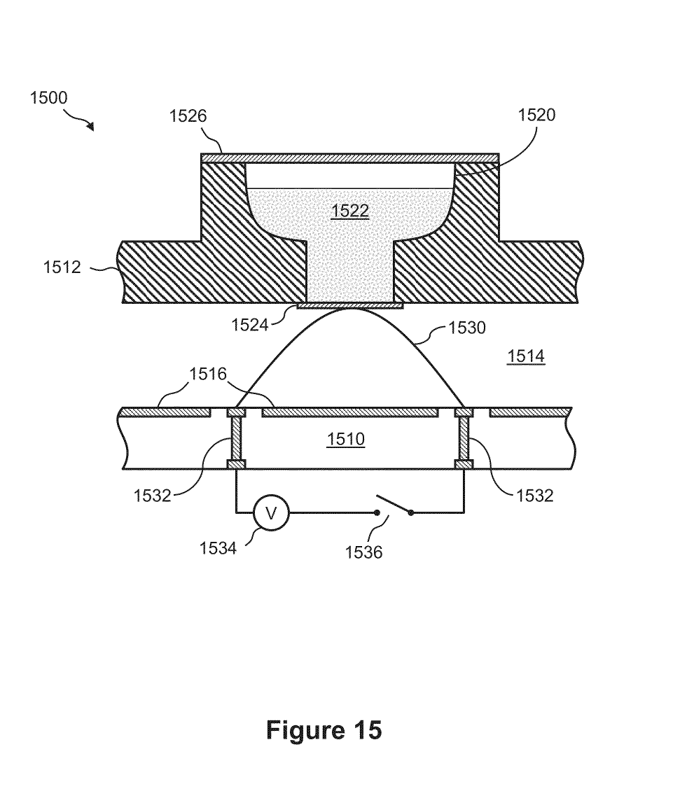

FIG. 14 illustrates a cross-sectional view (not to scale) of a pipette-style dispenser 1450, which is another example of a pipette-style dispenser, for loading liquid into a droplet actuator 1400. Droplet actuator 1400 includes a bottom substrate 1410 and a top substrate 1412 that are separated by a droplet operations gap 1414. Bottom substrate 1410 may include an arrangement of droplet operations electrodes 1416 (e.g., electrowetting electrodes). Droplet operations are conducted atop droplet operations electrodes 1416 on a droplet operations surface.

Pipette-style dispenser 1450 includes a barrel 1452 for holding a quantity of liquid 1454. Liquid 1454 is, for example, sample fluid, liquid reagent, or filler fluid. Barrel 1452 is, for example, an hourglass-shaped or cylinder-shaped barrel that has a flared outlet 1456. A seal 1458 at flared outlet 1456 and a seal 1460 at the inlet of barrel 1452 are used to retain liquid 1454 inside of pipette-style dispenser 1450 until liquid 1454 is ready for use. Seal 1458 and seal 1460 are, for example, foil seals or cellophane seals. In another example, a removable cap is provided at flared outlet 1456 of barrel 1452 instead of seal 1458. Optionally, pipette-style dispenser 1450 can be vacuum-sealed. Additionally, pipette-style dispenser 1450 includes a versapor oleophobic membrane 1462 atop seal 1460 at the inlet of barrel 1452. Versapor oleophobic membrane 1462 is an acrylic copolymer membrane cast on a non-woven nylon support. In one example, versapor oleophobic membrane 1462 is the Versapor® membrane available from Pall Corporation (Port Washington, N.Y.). The Versapor® membrane is available in a variety of pore sizes ranging, for example, from 0.2 μm to 5.0 μm.

A piercer 1470 is associated with pipette-style dispenser 1450. Piercer 1470 is, for example, a fine tip needle. When using pipette-style dispenser 1450, the user uses piercer 1470 to puncture seal 1460. Namely, the user pushes the tip of piercer 1470 through both the versapor oleophobic membrane 1462 and the seal 1460. The size of the tip of piercer 1470 is selected to be less than or equal to the pore size of versapor oleophobic membrane 1462. In one example, if the pore size of versapor oleophobic membrane 1462 is 3.0 μm, then the size of the tip of piercer 1470 is >3.0 μm. In this way, the tip of piercer 1470 can penetrate versapor oleophobic membrane 1462 without damaging it and therefore without compromising its sealing capabilities. As a result, seal 1460 can be punctured using piercer 1470, at the same time the inlet of pipette-style dispenser 1450 can remain sealed by versapor oleophobic membrane 1462.

A loading port 1420 is integrated into top substrate 1412 for loading liquid into the droplet operations gap 1414 of droplet actuator 1400. Further, loading port 1420 is designed to receive pipette-style dispenser 1450. In this example, a piercing edge 1422 is provided at the inlet of loading port 1420. That is, the inlet of loading port 1420 is designed to provide a hollow piercing mechanism for piercing seal 1458 at flared outlet 1456 of pipette-style dispenser 1450. Additionally, the shape of piercing edge 1422 substantially corresponds to the taper in flared outlet 1456 of pipette-style dispenser 1450. An outlet 1424 of loading port 1420 faces droplet operations gap 1414.

The operation of pipette-style dispenser 1450 for loading liquid 1454 into droplet actuator 1400 is as follows. First, the user seats flared outlet 1456 of pipette-style dispenser 1450 onto piercing edge 1422 of loading port 1420 of droplet actuator 1400. In so doing, piercing edge 1422 breaks seal 1458 of pipette-style dispenser 1450. Additionally, when flared outlet 1456 of pipette-style dispenser 1450 is seated onto piercing edge 1422 of loading port 1420, the outer surface of piercing edge 1422 seals against the inner surface of flared outlet 1456. Pipette-style dispenser 1450 is now ready to dispense liquid 1454 into droplet actuator 1400. Next, the user pushes the tip of piercer 1470 through both the versapor oleophobic membrane 1462 and seal 1460 of pipette-style dispenser 1450 in order to puncture seal 1460. Next, the user removes piercer 1470 from pipette-style dispenser 1450, leaving a puncture in seal 1460 that allows pipette-style dispenser 1450 to vent; namely, versapor oleophobic membrane 1462 is suitably porous that air will pass therethrough. Having vented pipette-style dispenser 1450, liquid 1454 flows out of pipette-style dispenser 1450 and into the droplet operations gap 1414 of droplet actuator 1400. Once, pipette-style dispenser 1450 is empty of liquid 1454, the user may remove pipette-style dispenser 1450 from loading port 1420 of droplet actuator 1400. The empty pipette-style dispenser 1450 can be discarded or reloaded with liquid 1454 and resealed for another use.

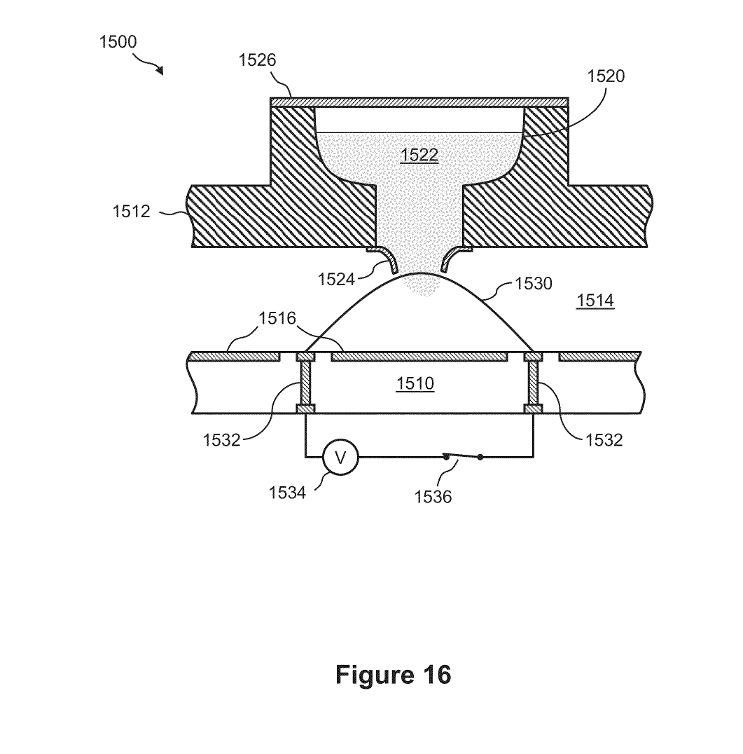

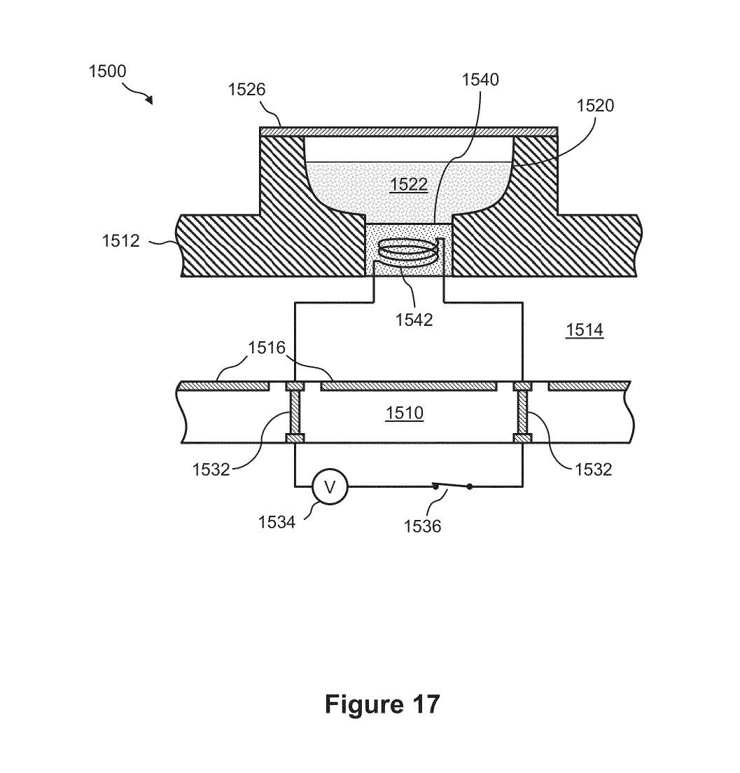

FIGS. 15 and 16 illustrate cross-sectional views (not to scale) of a portion of a droplet actuator 1500 that includes an electric wire for rupturing seals in a droplet actuator. Droplet actuator 1500 includes a bottom substrate 1510 and a top substrate 1512 that are separated by a droplet operations gap 1514. Bottom substrate 1510 may include an arrangement of droplet operations electrodes 1516 (e.g., electrowetting electrodes). Droplet operations are conducted atop droplet operations electrodes 1516 on a droplet operations surface.

An off-actuator reservoir 1520 is integrated into top substrate 1512 for holding a quantity of liquid 1522. Liquid 1522 is, for example, sample fluid, liquid reagent, or filler fluid. Off-actuator reservoir 1520 is sealed until liquid 1522 is ready for use. For example, an outlet of off-actuator reservoir 1520 has a seal 1524 and an inlet of off-actuator reservoir 1520 has a seal 1526. Seal 1524 at the outlet is, for example, a foil seal or cellophane seal. Seal 1524 is arranged in or near the droplet operations gap 1514, as shown. Seal 1526 at the inlet of off-actuator reservoir 1520 is, for example, a versapor oleophobic membrane, or the combination of a versapor oleophobic membrane and foil. If the latter, seal 1526 must include a small portion that is absent foil so that off-actuator reservoir 1520 can vent through versapor oleophobic membrane, which is porous.

Droplet actuator 1500 further includes a wire 1530 for rupturing seal 1524 that is arranged in or near the droplet operations gap 1514. For example, a loop of wire 1530 is arranged between two electrical connections 1532 in bottom substrate 110. A voltage source 1534 that is controlled by a switch 1536 supplies the two electrical connections 1532 of nitinol wire 1530.

Namely, wire 1530 loops between the two electrical connections 1532 and across droplet operations gap 1514 in an arching fashion. A center portion of the arching wire 1530 is bonded to seal 1524, as shown. In one example, if seal 1524 is a foil seal then wire 1530 can be soldered to seal 1524. In another aspect of an embodiment, if seal 1524 is a foil seal then wire 1530 can be adhered to seal 1524 with at least one adhesive. In yet another aspect of an embodiment, if seal 1524 is a foil seal then wire 1530 can be induction welded to seal 1524. In a further aspect of an embodiment, if seal 1524 is a foil seal then wire 1530 can be swaged to seal 1524. Wire 1530 an electrically conductive wire formed of nickel titanium (aka nitinol). Nitinol alloys exhibit two closely related and unique properties: shape memory and superelasticity. Shape memory refers to the ability of nitinol to undergo deformation at one temperature, then recover its original, undeformed shape at another temperature. In droplet actuator 1500, nitinol wire 1530 is heated by passing an electric current therethrough. Consequently, nitinol wire 1530 has one arching shape when no electric current is present therein and deforms to a slightly different arching shape when an electric current is present therein.

In operation and referring now to FIG. 15, when switch 1536 is open the voltage source 1534 is not connected to nitinol wire 1530. Consequently, no current is flowing through nitinol wire 1530 and thus no heating occurs in nitinol wire 1530. In this state, the arching nitinol wire 1530 that is bonded to seal 1524 exerts substantially no stress upon seal 1524. Therefore, seal 1524 remains intact and unbroken and liquid 1522 is retained in off-actuator reservoir 1520. However and referring now to FIG. 16, to dispense liquid 1522 from off-actuator reservoir 1520 into droplet operations gap 1514, switch 1536 is closed, thereby connecting voltage source 1534 to nitinol wire 1530. This causes an electric current to flow in nitinol wire 1530, which in turn causes heating to occur in nitinol wire 1530. When nitinol wire 1530 is heated, its arching shape slightly deforms and pulls away from off-actuator reservoir 1520. In so doing, seal 1524 is ruptured and liquid 1522 flows into droplet operations gap 1514. Off-actuator reservoir 1520 vents through the versapor oleophobic membrane of seal 1526, which is porous.

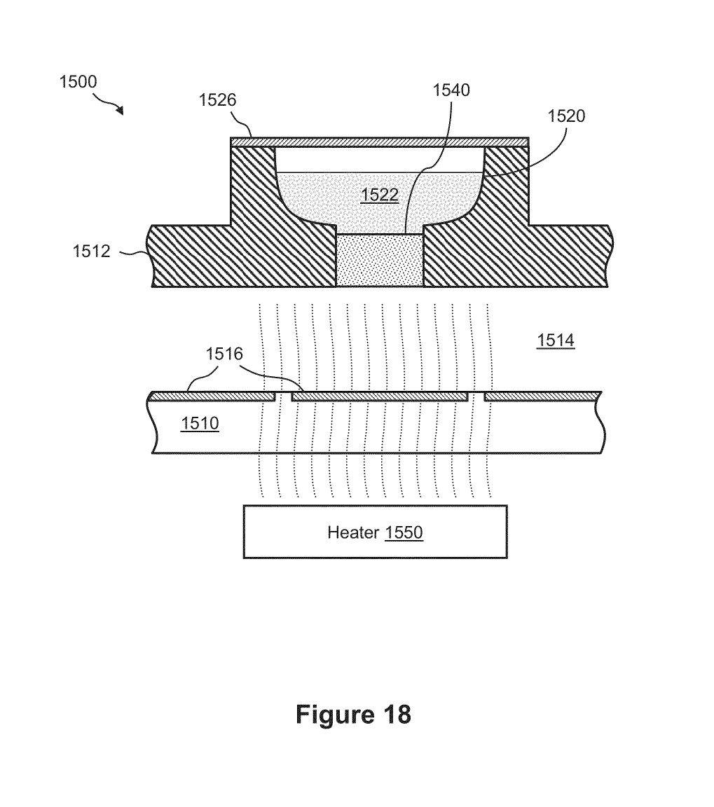

FIGS. 17 and 18 illustrate cross-sectional views (not to scale) of a portion of droplet actuator 1500 and methods of using wax seals in the outlet of a reservoir. In FIGS. 17 and 18, instead of droplet actuator 1500 including seal 1524, which is a foil seal or cellophane seal, at the outlet of off-actuator reservoir 1520, droplet actuator 1500 includes a plug 1540 at the outlet of off-actuator reservoir 1520. Plug 1540 is, for example, a low-melting-point plastic or silicone wax. Examples of silicone wax are:
(1) POLYOCTADECYLMETHYLSILOXANE, viscosity (cSt)=250-500@50° C., pour point=50° C., and
(2) 27-33% OCTADECYLMETHYLSILOXANE)-(DIMETHYLSILOXANE) COPOLYMER, viscosity (cSt)=200-500@50° C., pour point-40° C.

The plug 1540 can be ruptured by heating in order to dispense liquid 1522 into droplet operations gap 1514. In one example and referring now to FIG. 17, a resistive electric coil 1542 is embedded in plug 1540. Resistive electric coil 1542 is electrically connected to voltage source 1534. When switch 1536 is closed and voltage source 1534 is electrically connected to resistive electric coil 1542, an electric current flows through resistive electric coil 1542. The electric current causes resistive electric coil 1542 to heat up, which causes plug 1540 to melt and thereby release liquid 1522 into droplet operations gap 1514. When plug 1540 melts, it dissolves into or is in a suspension in the filler fluid (not shown), which is, for example, silicone oil.

In another example and referring now to FIG. 18, an external heat source, such as a heater 1550, is used to supply heat energy to droplet actuator 1500. The heat energy causes plug 1540 to melt and thereby release liquid 1522 into droplet operations gap 1514.

In yet another example, plug 1540 is a silicone-oil-soluble wax, such as 1-2% TRIACONTYLMETHYLSILOXANE)-(DIMETHYLSILOXANE) COPOLYMER having a viscosity (cSt)=2,000-4,000@room temperature. In this example, when droplet operations gap 1514 of droplet actuator 1500 is filled with silicone oil, the silicone oil dissolves plug 1540 and liquid 1522 is released into droplet operations gap 1514.

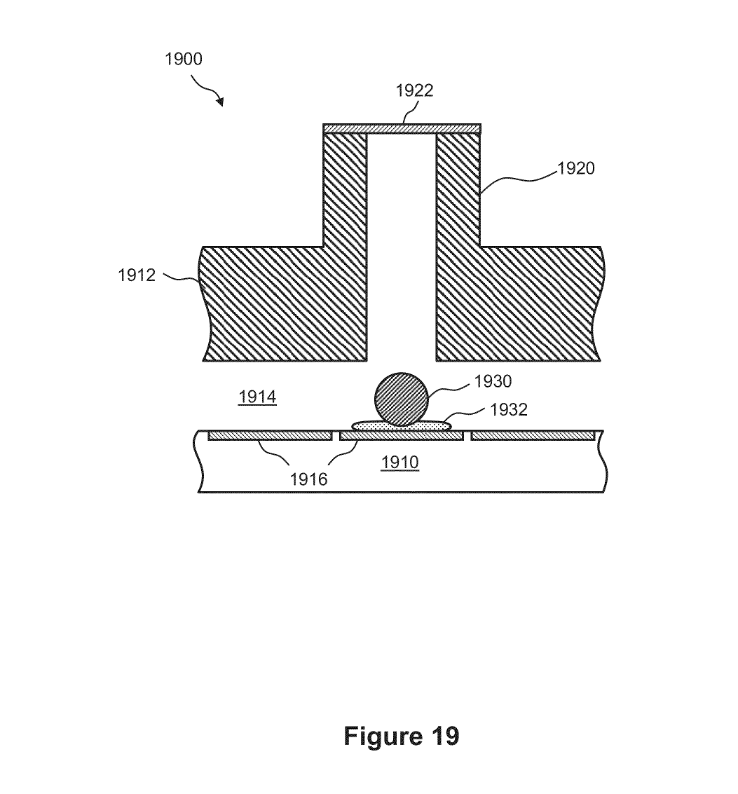

FIG. 19 illustrates a cross-sectional view (not to scale) of a portion of droplet actuator 1900 and a method of using silicone-oil-soluble wax for retaining lyophilized beads or encapsulated liquid reagent in the droplet operations gap. Droplet actuator 1900 includes a bottom substrate 1910 and a top substrate 1912 that are separated by a droplet operations gap 1914. Droplet operations gap 1914 contains filler fluid (not shown). Bottom substrate 1910 may include an arrangement of droplet operations electrodes 1916 (e.g., electrowetting electrodes). Droplet operations are conducted atop droplet operations electrodes 1916 on a droplet operations surface.

A loading port 1920 is integrated into top substrate 1912 for loading filler fluid, such as silicone oil, into the droplet operations gap 1914 of droplet actuator 1900. An inlet of loading port 1920 may be sealed with a seal 1922 (e.g., a foil seal or cellophane seal or versapor oleophobic membrane) until ready for use. A bead 1930 is retained in droplet operations gap 1914 using silicone-oil-soluble wax 1932. For example, before droplet operations gap 1914 is filled with filler fluid, a smear of silicone-oil-soluble wax 1932 is provided in a softened or melted state on the surface of bottom substrate 1910. While in the softened or melted state, bead 1930 is stuck into silicone-oil-soluble wax 1932. Then, silicone-oil-soluble wax 1932 is allowed to harden and thereby retain bead 1930 therein. In one example, bead 1930 is a lyophilized bead. In another example, bead 1930 is an encapsulated liquid reagent. According to aspects of embodiments, one or more encapsulants may be formed of one or more of oil or water. Additional aspects of embodiments include an encapsulant that may be soluble at about room, a temperature above room temperature, and/or a temperature in the range about 25 degrees Celsius to about 100 degrees Celsius.

In operation, seal 1922 is removed and loading port 1920 is used to load the droplet operations gap 1914 of droplet actuator 1900 with filler fluid, such as silicon oil. Once silicon oil enters the droplet operations gap 1914, the silicon oil dissolves silicone-oil-soluble wax 1932 and releases bead 1930. Bead 1930 is now free to be manipulated in the droplet operations gap 1914. Those skilled in the art will recognize that multiple beads 1930 can be retained in the droplet operations gap 1914 using silicone-oil-soluble wax 1932. This technique may be useful for preloading and storing beads in a droplet actuator until ready for use. In other embodiment, the wax is not silicone-oil-soluble. Instead, the wax is a low-melting-point silicone wax that can be melted by heating to release the beads.

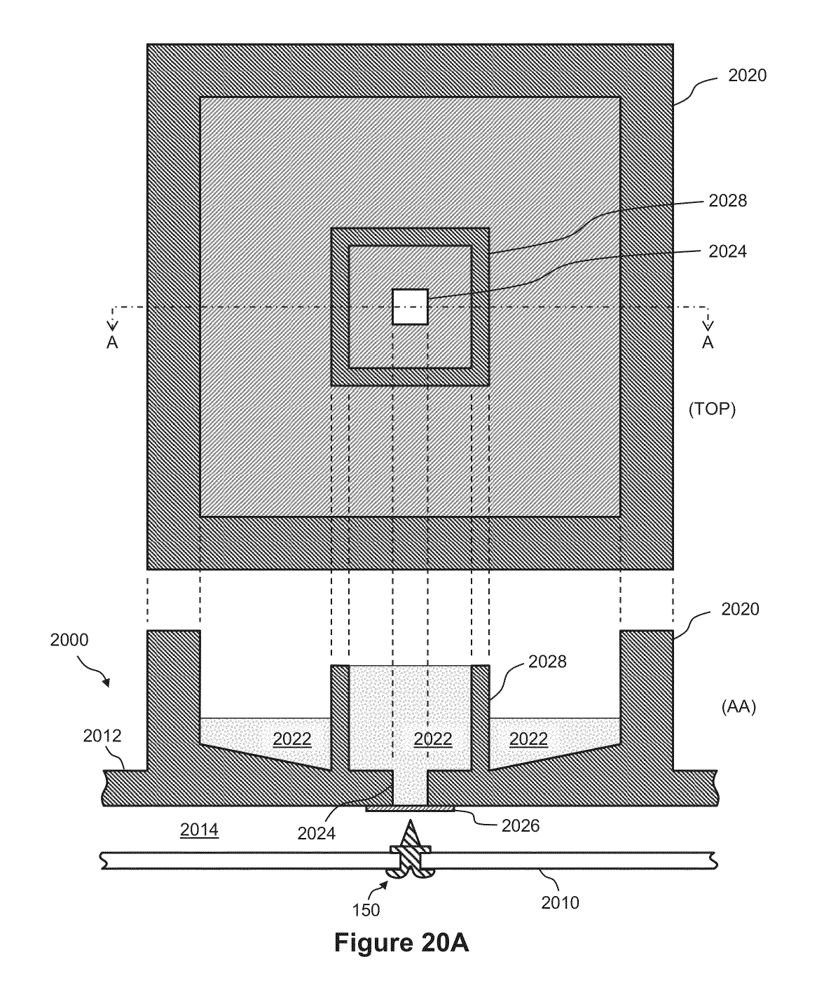

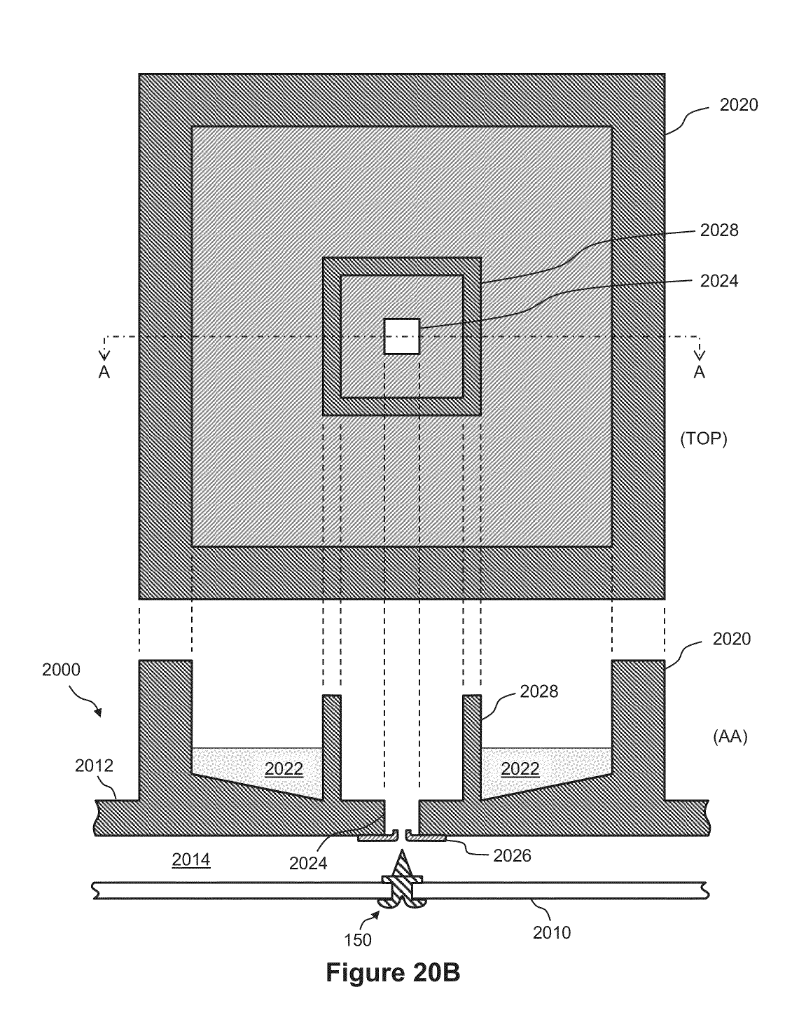

FIGS. 20A and 20B illustrate top views and cross-sectional views (not to scale) of a portion of a droplet actuator 2000 that includes an off-actuator reservoir for metering a certain volume of liquid into droplet actuator 2000. The cross-sectional view in FIGS. 20A and 20B is taken along line AA of the top view of FIGS. 20A and 20B. Droplet actuator 2000 includes a bottom substrate 2010 and a top substrate 2012 that are separated by a droplet operations gap 2014. Bottom substrate 2010 may include an arrangement of droplet operations electrodes (not shown).

An off-actuator reservoir 2020 is integrated into top substrate 2012 for holding a quantity of liquid 2022. Liquid 2022 is, for example, sample fluid, liquid reagent, or filler fluid. Off-actuator reservoir 2020 has an outlet 2024, which has a seal 2026 for retaining liquid 2022 inside of off-actuator reservoir 2020 until ready for use. Seal 2026 at the outlet is, for example, a foil seal or cellophane seal. Piercer 150 is installed in bottom substrate 2010 such that pointed tip 152 of piercer 150 is disposed in droplet operations gap 2014 and in close proximity to seal 2026.

Off-actuator reservoir 2020 is designed for metering a certain volume of liquid 2022 into droplet actuator 2000. For example, a weir 2028 is installed inside of off-actuator reservoir 2020 and surrounding outlet 2024. Weir 2028 is used to control the maximum amount of liquid 2022 that is allowed into the workspace of droplet actuator 2000. More specifically, weir 2028 is designed to hold an amount of liquid 2022 that substantially corresponds to the amount of liquid 2022 that droplet actuator 2000 is designed to receive. In one example, if droplet actuator 2000 is designed to receive 400 μl of liquid 2022, then weir 2028 is designed to hold 400 μl of liquid. In another example, if droplet actuator 2000 is designed to receive 600 μl of liquid 2022, then weir 2028 is designed to hold 600 μl of liquid.

In operation, if a user loads off-actuator reservoir 2020 with a quantity of liquid 2022 that exceeds the amount that droplet actuator 2000 is designed to receive, the excess liquid 2022 overflows weir 2028 and is retained inside of off-actuator reservoir 2020 but outside of weir 2028, as shown in FIG. 20A. Using weir 2028, the overflow liquid 2022 is held back from entering droplet operations gap 2014 of droplet actuator 2000. For example, when seal 2026 is punctured using piercer 150, only the volume of liquid 2022 inside of weir 2028 flows through outlet 2024 and into droplet operations gap 2014, whereas the volume of liquid 2022 outside of weir 2028 is held back by weir 2028 and retained inside of off-actuator reservoir 2020, as shown in FIG. 20B.

Additionally, the inlet of off-actuator reservoir 2020 may be capped, covered, or otherwise sealed. Further, a cap or cover (not shown) of off-actuator reservoir 2020 may include a loading port (not shown) for guiding liquid 2022 into weir 2028 when off-actuator reservoir 2020 is being loaded.

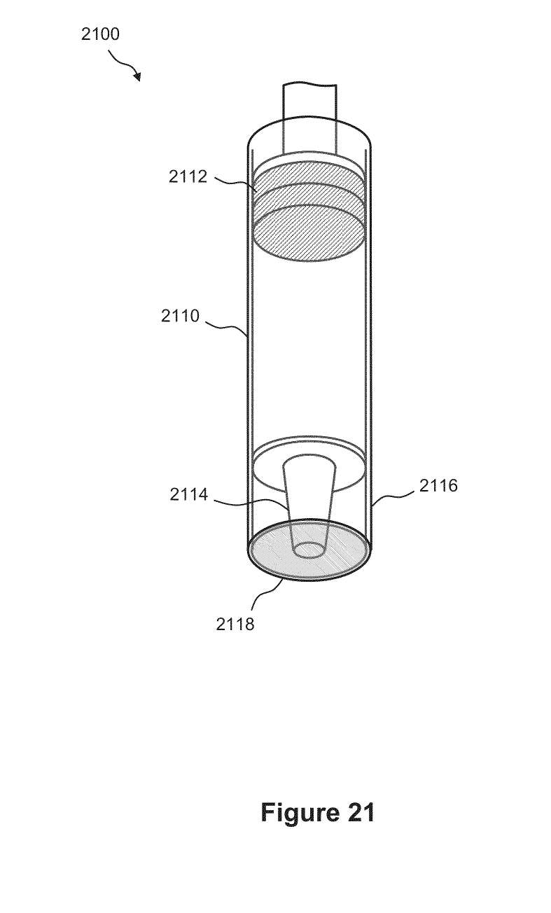

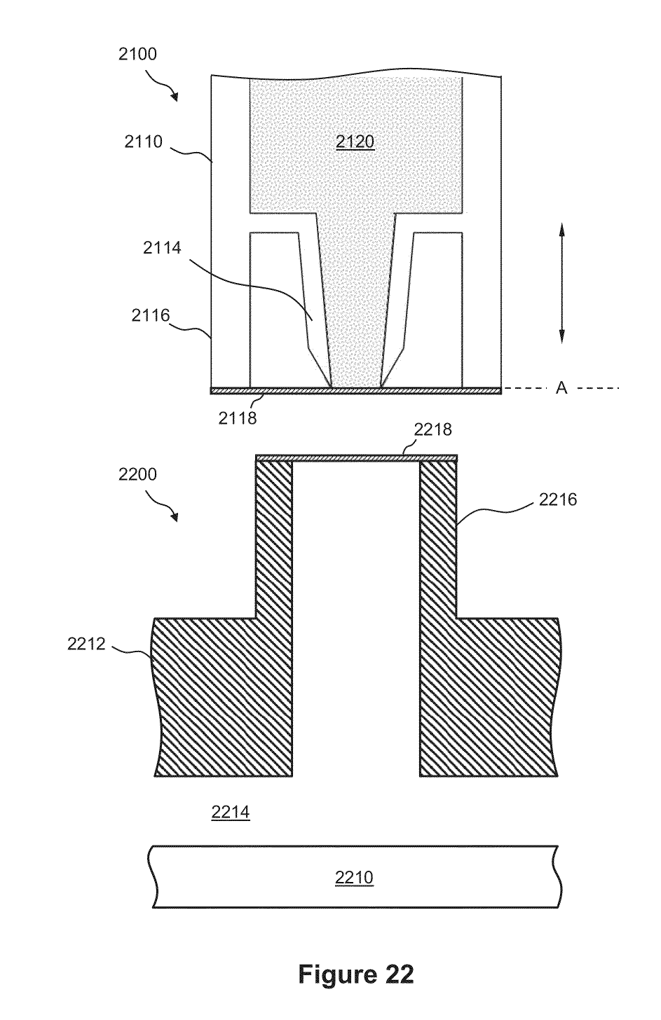

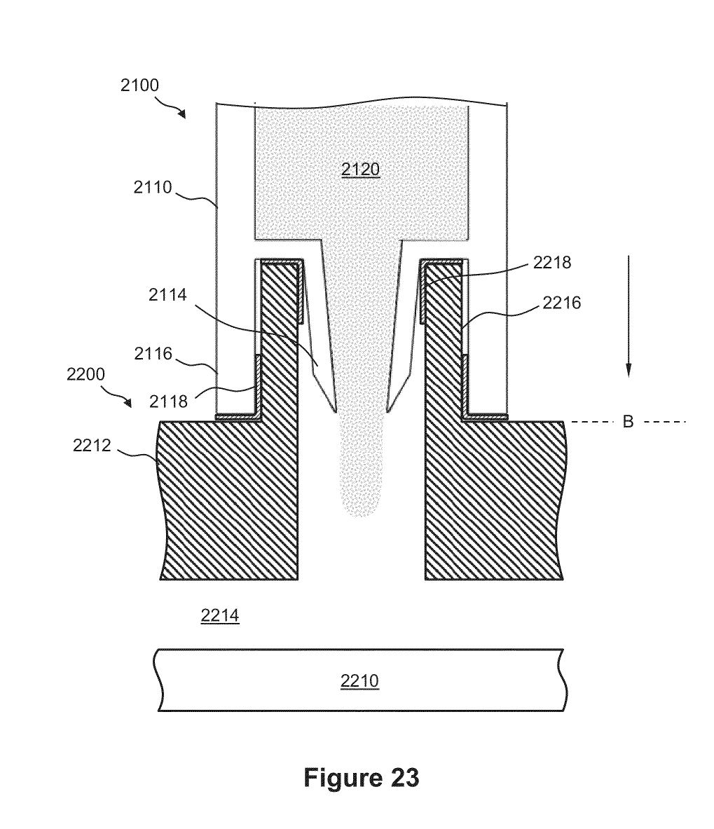

FIG. 21 illustrates an isometric view (not to scale) of a syringe 2100 whose outlet tip is designed for piercing the seal of a loading port of a droplet actuator. Syringe 2100 includes a barrel 2110 for holding a quantity of liquid (not shown). Fitted into one end of barrel 2110 is a plunger 2112. An outlet 2114 is provided at the other end of barrel 2110. Outlet 2114 is narrow tapered outlet. When loaded with liquid, plunger 2112 is used to push liquid out of outlet 2114 of syringe 2100. Further, the outer edge of outlet 2114 is sharp enough to pierce a seal, such as a foil seal or cellophane seal. Additionally, a shroud 2116 surrounds outlet 2114. Shroud 2116 is designed to be press fitted onto a corresponding receptacle of a loading port of a droplet actuator, which is shown with reference to FIGS. 22 and 23. Syringe 2100 may be preloaded with liquid (e.g., sample fluid or liquid reagent) and then outlet 2114 is sealed with a seal 2118 that spans both outlet 2114 and shroud 2116. Seal 2118 is, for example, a foil seal or cellophane seal.

FIGS. 22 and 23 illustrate cross-sectional views of a portion of droplet actuator 2200 that includes a loading port that is designed to receive syringe 2100 of FIG. 21 and a process of using syringe 2100. Droplet actuator 2200 includes a bottom substrate 2210 and a top substrate 2212 that are separated by a droplet operations gap 2214. Bottom substrate 2210 may include an arrangement of droplet operations electrodes (not shown).

A loading port 2216 is integrated into top substrate 2212. An inlet of loading port 2216 has a seal 2218. Seal 2218 is, for example, a foil seal or cellophane seal. Loading port 2216 is designed to receive shroud 2116 of syringe 2100. Namely, loading port 2216 is designed to be press fitted inside of shroud 2116 of syringe 2100.

FIG. 22 shows syringe 2100 in a position A with respect to loading port 2216 of droplet actuator 2200. In position A, syringe 2100 is loaded with liquid 2120 (e.g., sample fluid, liquid reagent, or filler fluid) but not yet mechanically or fluidly coupled to loading port 2216 of droplet actuator 2200. Seal 2118 is still intact across outlet 2114 and shroud 2116.

In order to dispense liquid 2120 from syringe 2100 into droplet operations gap 2214 of droplet actuator 2200, first, the user removes seal 2118 from syringe 2100. Next, the user press fits shroud 2116 of syringe 2100 onto the corresponding receptacle of loading port 2216 of droplet actuator 2200, as shown in FIG. 23. Namely, FIG. 23 shows syringe 2100 in a position B with respect to loading port 2216. In position B, syringe 2100 is mechanically or fluidly coupled to loading port 2216 of droplet actuator 2200. When the shroud 2116 of syringe 2100 is press fitted onto loading port 2216, the sharp edge of outlet 2114 pierces or punctures seal 2218 of loading port 2216. Then, the user uses plunger 2112 of syringe 2100 to dispense liquid 2120 into droplet operations gap 2214 of droplet actuator 2200.

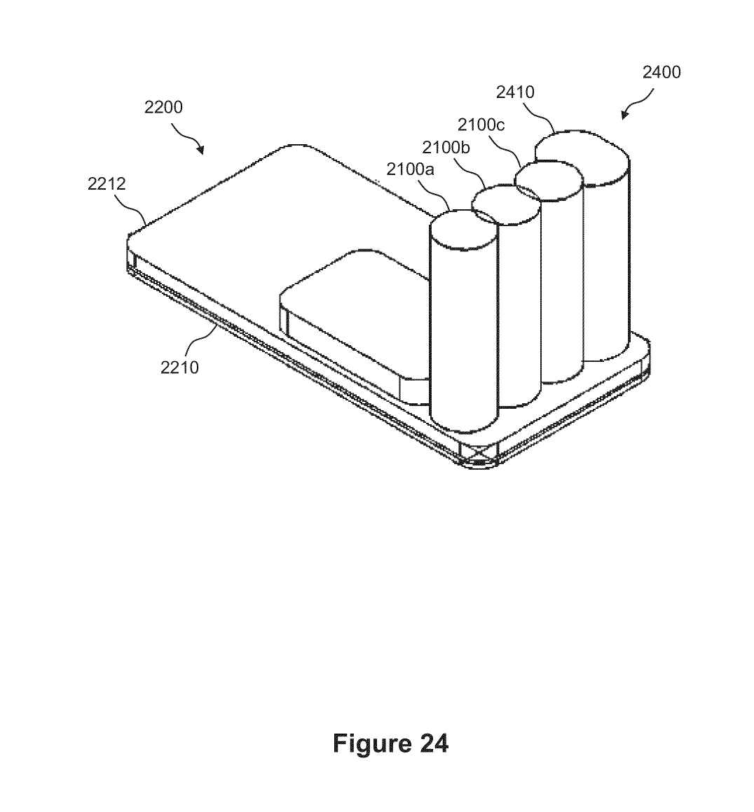

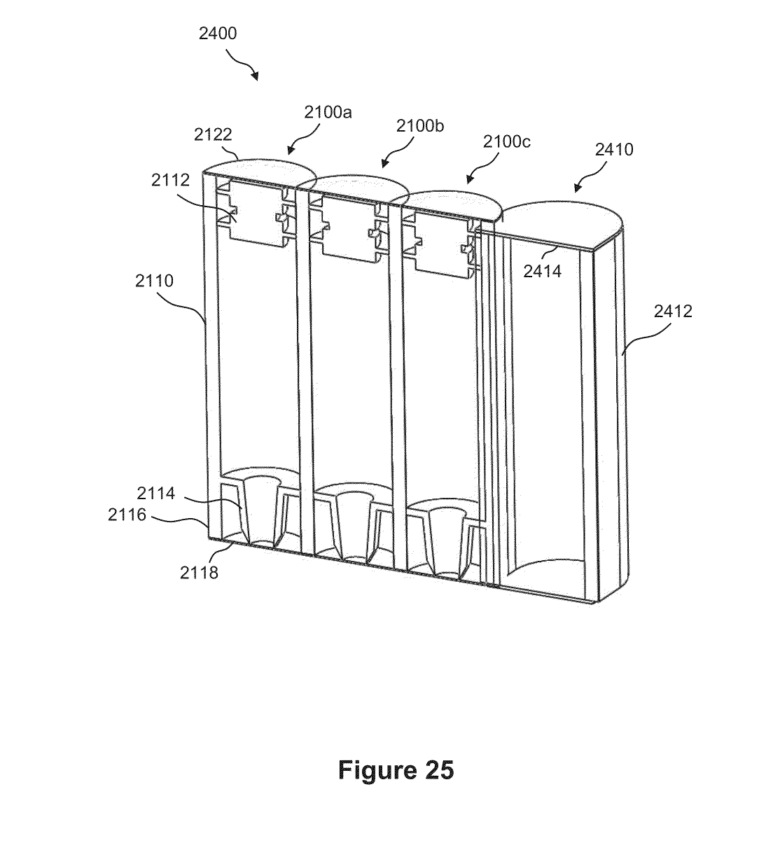

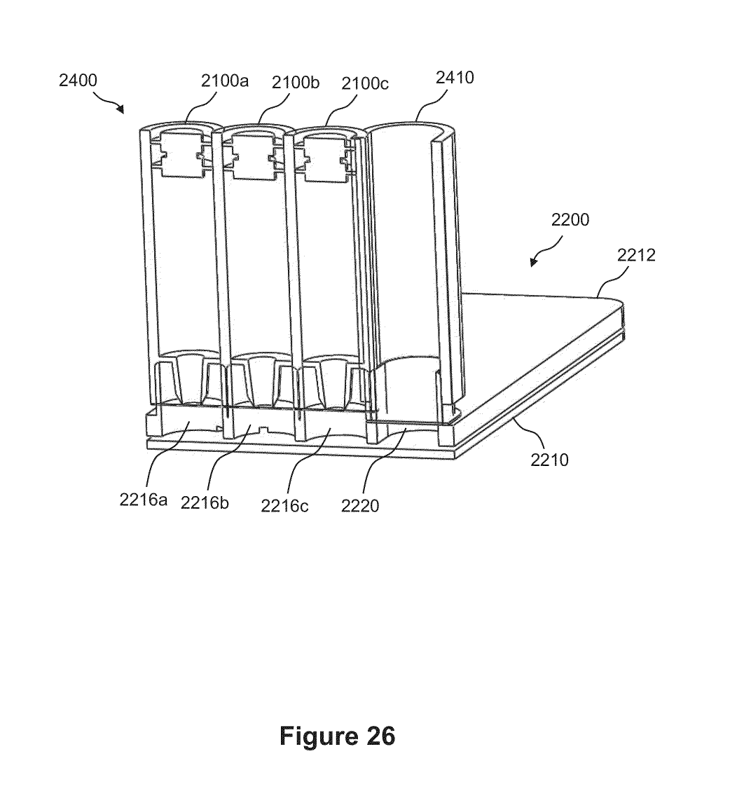

FIG. 24 illustrates an isometric view of a syringe assembly 2400 that is based on syringe 2100 and loading port 2216 that are described with reference to FIGS. 21, 22, and 23. For example, FIG. 24 show syringe assembly 2400 installed on droplet actuator 2200. In this example, syringe assembly 2400 includes an arrangement of three syringes 2100; namely, a syringe 2100a, a syringe 2100b, and a syringe 2100c. Syringe assembly 2400 further includes a filler fluid loading channel 2410. More details of syringe assembly 2400 in combination with droplet actuator 2200 are described with reference to FIGS. 25 and 26.

FIG. 25 illustrates a cross-sectional view of syringe assembly 2400 of FIG. 24. This view shows that each of the syringes 2100a, 2100b, and 2100c include a barrel 2110, a plunger 2112, an outlet 2114, and a shroud 2116. Filler fluid loading channel 2410 includes a hollow body or cylinder 2412. In syringe assembly 2400, the end of syringes 2100a, 2100b, and 2100c in which plunger 2112 is installed may be sealed with a seal 2122 until ready for use. Additionally, the inlet of filler fluid loading channel 2410 may be sealed with a seal 2414 until ready for use. Seal 2122 and seal 2414 are, for example, a foil seal or cellophane seal. In one example, syringes 2100a, 2100b, and 2100c and filler fluid loading channel 2410 are sealed separately. In another example, a continuous seal is used to seal all of syringes 2100a, 2100b, and 2100c and filler fluid loading channel 2410. Further, FIG. 25 shows one continuous seal 2118 at the outlets of syringes 2100a, 2100b, and 2100c and of filler fluid loading channel 2410, but individual seals could be provided instead.

FIG. 26 illustrates a cross-sectional view of syringe assembly 2400 of FIG. 24 installed on droplet actuator 2200. Namely, syringe assembly 2400 is in position B (see FIG. 23) with respect to droplet actuator 2200. FIG. 26 shows that all seals have been removed from syringe assembly 2400 and three shrouds 2116 (e.g., shrouds 2116a, 2116b, and 2116c) are fitted onto three respective loading ports 2216. In so doing, the three respective seals 2218 are ruptured. Droplet actuator 2200 further includes a loading port 2220 for receiving filler fluid loading channel 2410.

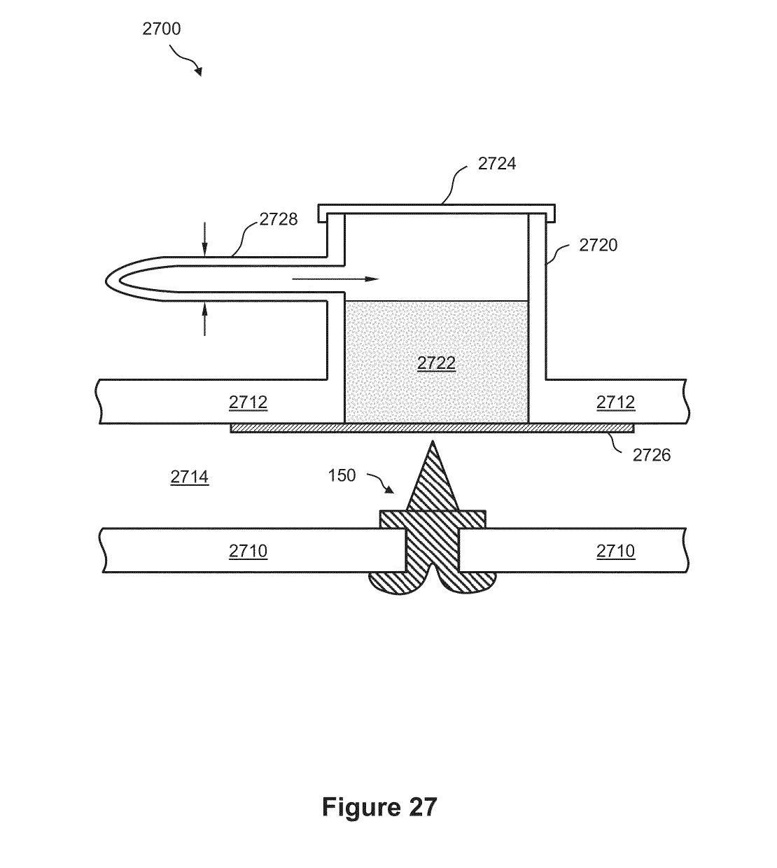

FIGS. 27, 28, and 29 illustrate cross-sectional views (not to scale) of a portion of a droplet actuator 2700 that includes an off-actuator reservoir that has a bladder for controlling the amount of liquid dispensed therefrom. Droplet actuator 2700 includes a bottom substrate 2710 and a top substrate 2712 that are separated by a droplet operations gap 2714. Bottom substrate 2710 may include an arrangement of droplet operations electrodes (not shown).

An off-actuator reservoir 2720 is integrated into top substrate 2712 for holding a quantity of liquid 2722. Liquid 2722 is, for example, sample fluid, liquid reagent, or filler fluid. An inlet of off-actuator reservoir 2720 is enclosed using a cover 2724. Cover 2724 may be any type of removable or non-removable cap, cover, or seal. For example, cover 2724 can be a hinged cap, a snap-fitted cap, a foil seal, or a cellophane seal. A seal 2726 is provided at an outlet of off-actuator reservoir 2720, which faces droplet operations gap 2714. Seal 2726 is, for example, a foil seal or cellophane seal that can be punctured using piercer 150 that is installed in bottom substrate 2710 of droplet actuator 2700.

Off-actuator reservoir 2720 further includes a bladder 2728 that is squeezable. Namely, squeezing bladder 2728 collapses the walls of bladder 2728 together and forces out any air or liquid 2722 that is present therein. In one example, bladder 2728 is a hollow plastic tube that is closed (i.e., sealed) on one end and open on the end that is coupled to the sidewall of off-actuator reservoir 2720. A hollow plastic tube is but one example of implementing bladder 2728; other methods of implementing bladder 2728 are possible.

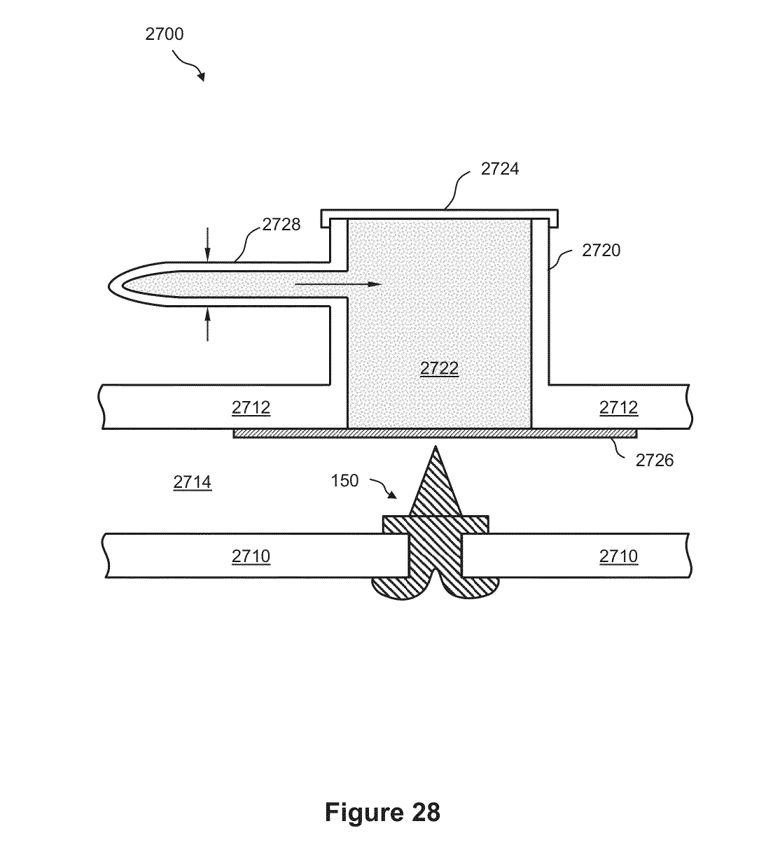

Referring now to FIG. 27, off-actuator reservoir 2720 is partially filled with liquid 2722 and partially filled with air. More particularly, the level of liquid 2722 is such that bladder 2728 is substantially filled with air. Referring now to FIG. 28, off-actuator reservoir 2720 is substantially entirely filled with liquid 2722. In so doing, bladder 2728 is substantially filled with liquid 2722. In operation, first, seal 2726 is punctured using piercer 150. Next, the user squeezes bladder 2728, which displaces air (in FIG. 27) or liquid 2722 (in FIG. 28) out of bladder 2728 and into off-actuator reservoir 2720 that in turn displaces liquid 2722 out of the outlet of off-actuator reservoir 2720 and into droplet operations gap 2714 of droplet actuator 2700. Essentially, bladder 2728 provides a positive displacement pump that is used to pump liquid 2722 out of off-actuator reservoir 2720 and into droplet actuator 2700.

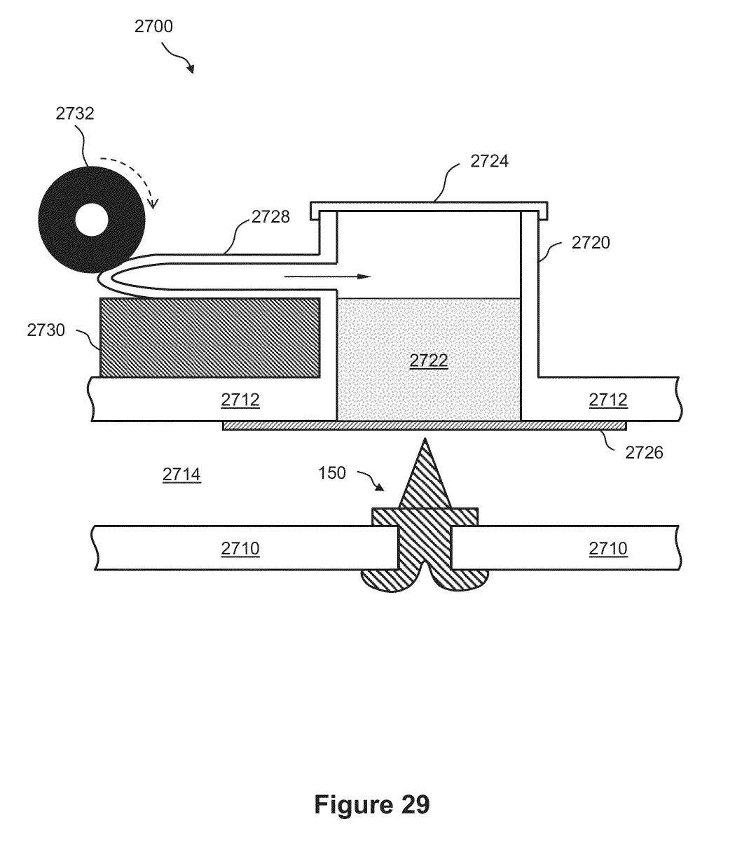

A mechanical mechanism can be provided for squeezing bladder 2728. In one example and referring now to FIG. 29, a support 2730 is provided between top substrate 2712 and bladder 2728. Then, a wheel or roller 2732 is provided for squeezing bladder 2728 against support 2730, which pumps liquid 2722 out of off-actuator reservoir 2720. The invention is not limited to a wheel or roller 2732 for squeezing bladder 2728, any other mechanisms capable of squeezing bladder 2728 are possible.

In FIGS. 27, 28, and 29, bladder 2728 of off-actuator reservoir 2720 can be sized to hold a certain volume. In this way, bladder 2728 can be used to control the amount of liquid 2722 that is dispensed out of off-actuator reservoir 2720. For example, if bladder 2728 is sized to hold 200 μl of air or liquid 2722, squeezing bladder 2728 causes 200 μl of liquid 2722 to be dispensed out of off-actuator reservoir 2720 and into droplet operations gap 2714 of droplet actuator 2700. Additionally, the proportion of the volume of off-actuator reservoir 2720 versus bladder 2728 can vary.

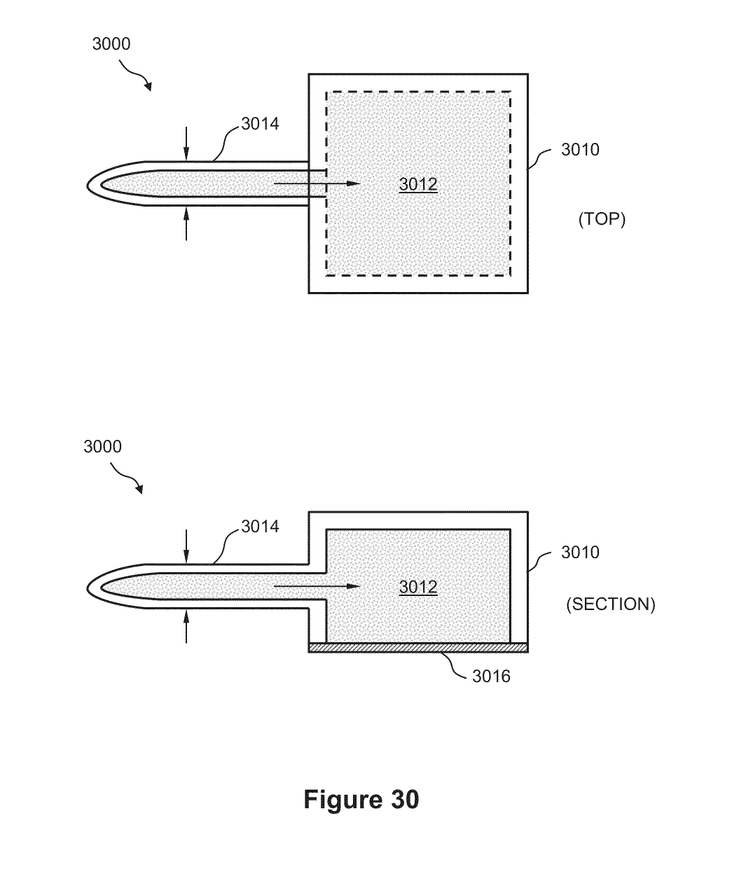

FIG. 30 illustrates a top down view and a cross-sectional view of an example of a disposable storage module 3000 that includes a bladder. Disposable storage module 3000 includes a storage reservoir 3010 for holding a quantity of liquid 3012. Liquid 3012 is, for example, sample fluid or liquid reagent. A bladder 3014 is fluidly coupled to a sidewall of a storage reservoir 3010. Bladder 3014 is substantially the same as bladder 2728 of off-actuator reservoir 2720 of FIGS. 27, 28, and 29.

Storage reservoir 3010 can be sized to hold any quantity of liquid 3012. Likewise, bladder 3014 can be sized to dispense any quantity of liquid 3012. In this way, bladder 3014 is used to control the amount of liquid 3012 that is dispensed from disposable storage module 3000. Additionally, the proportion of liquid 3012 stored in storage reservoir 3010 versus bladder 3014 can vary. In the example shown in FIG. 30, the majority of the volume of liquid 3012 is in storage reservoir 3010, with a comparatively smaller amount in bladder 3014. However, in another example, bladder 3014 is sized to hold the majority of the volume of liquid 3012, while storage reservoir 3010 is sized to hold a comparatively smaller amount of liquid 3012. In this example, storage reservoir 3010 serves primarily as the outlet mechanism of disposable storage module 3000.

A seal 3016 is provided at an outlet of storage reservoir 3010 for sealing liquid 3012 inside of disposable storage module 3000 until is ready for use. Seal 3016 is, for example, a foil seal or cellophane seal that can be ruptured using, for example, piercer 150 of FIG. 1.

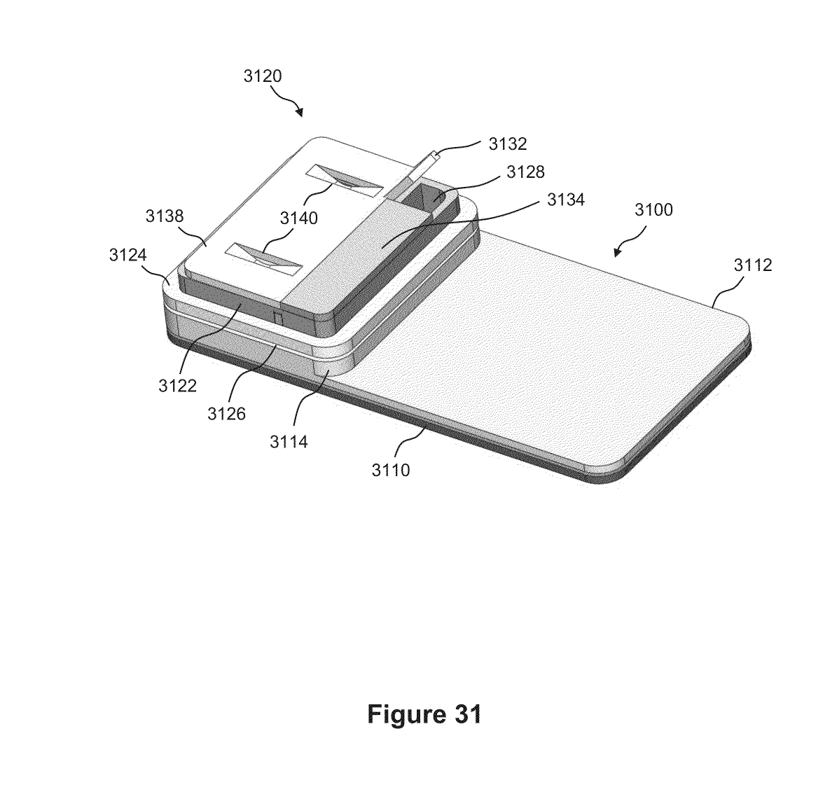

FIGS. 31 through 38 illustrate various views of a dispensing system 3120 in combination with a droplet actuator 3100, wherein dispensing system 3120 uses bladders for dispensing fluids therefrom.

Referring now to FIG. 31, an isometric view of droplet actuator 3100 to which dispensing system 3120 is mechanically and fluidly coupled is provided. Droplet actuator 3100 includes a bottom substrate 3110 and a top substrate 3112 that are separated by a droplet operations gap (not shown) that contains filler fluid (not shown). Bottom substrate 3110 may include an arrangement of droplet operations electrodes (not shown). A mounting flange 3114 is integrated into top substrate 3112 for receiving dispensing system 3120. Dispensing system 3120 includes a body 3122 that houses various compartments for holding a variety of fluids, such as filler fluid, sample fluids, liquid reagents, and the like. Body 3122 further includes a mounting flange 3124 that corresponds to mounting flange 3114 of top substrate 3112. Namely, body 3122 of dispensing system 3120 is, for example, snap-fitted into mounting flange 3114 of top substrate 3112. In so doing, mounting flange 3124 of dispensing system 3120 fits against mounting flange 3114 of top substrate 3112, with a seal 3126 therebetween. Seal 3126 is, for example, a rubber seal or gasket.

A portion of body 3122 houses one or more reservoirs. For example, body 3122 includes a single reservoir 3128 and a set of four reservoirs 3130. The single reservoir 3128 has a hinged cover 3132 and the set of four reservoirs 3130 has a cover 3134. The reservoir 3128 and reservoirs 3130 can vary in size, holding volumes of liquid ranging, for example, from about 100 μl to about 500 μl. In this example, dispensing system 3120 includes five reservoirs. However, this is exemplary only. Dispensing system 3120 can include any number of reservoirs.

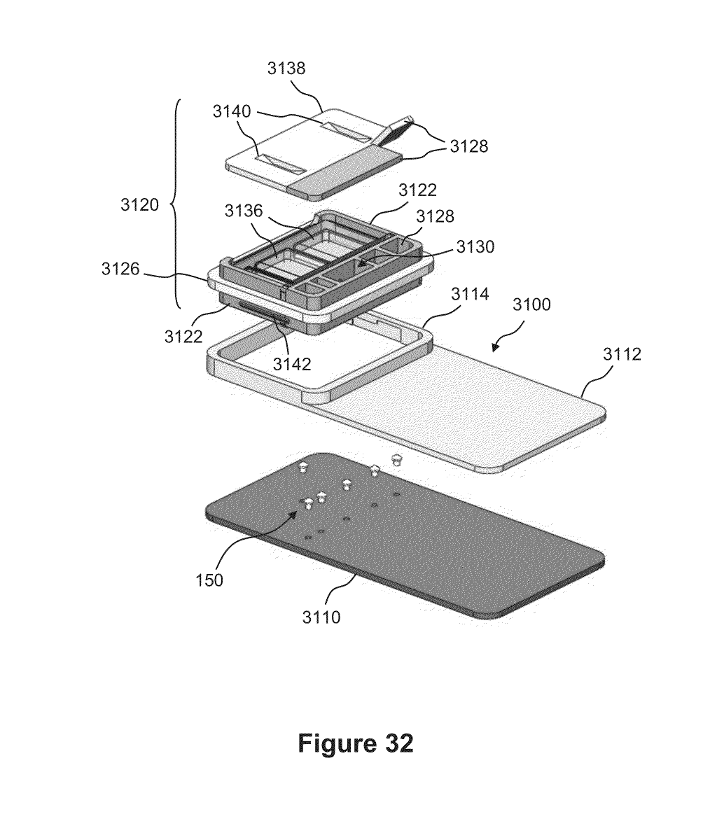

Another portion of body 3122 houses one or more bladders 3136 (not visible) that are associated with reservoir 3128 and reservoirs 3130. A cover 3138 covers the portion of body 3122 that houses the one or more bladders 3136 (not visible). Integrated into cover 3138 are, for example, two dispensing levers 3140. Dispensing levers 3140 are the mechanisms for squeezing the one or more bladders 3136 that are associated with reservoir 3128 and reservoirs 3130. Namely, dispensing levers 3140 and bladders 3136 are used for pumping liquid out of reservoir 3128 and reservoirs 3130 and into the droplet operations gap of droplet actuator 3100. More details of dispensing system 3120 are shown and described with reference to FIG. 32.

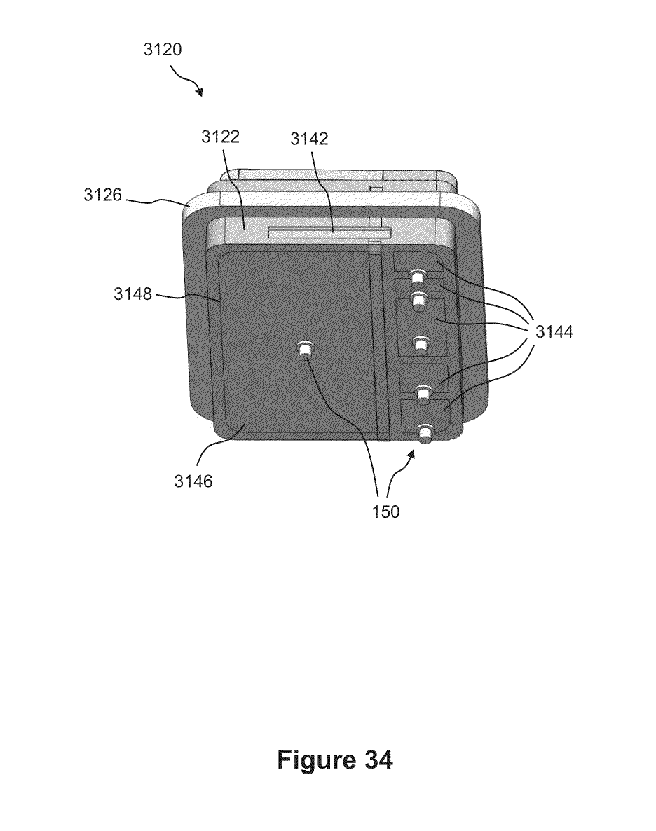

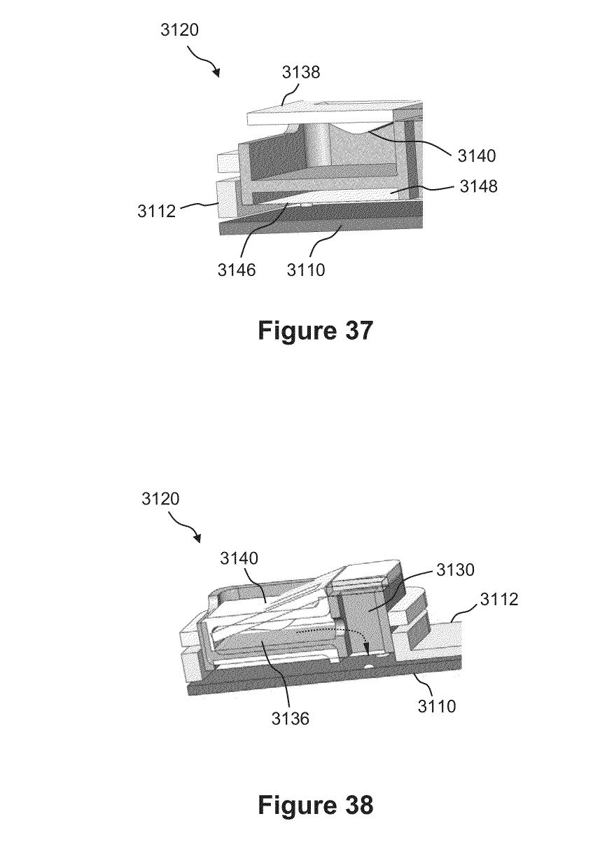

Referring now to FIG. 32, an exploded view of droplet actuator 3100 and dispensing system 3120 is provided that shows additional details thereof. For example, this view shows more details of reservoir 3128 and reservoirs 3130 in body 3122. This view also shows the one or more bladders 3136 in a compartment of body 3122. Additionally, certain locking features 3142 are integrated into body 3122 for coupling dispensing system 3120 to droplet actuator 3100. Beneath bladders 3136, dispensing system 3120 further includes a filler fluid reservoir 3148 (see FIGS. 34 and 37) for holding filler fluid to be dispensed into the droplet operations gap of droplet actuator 3100.

Referring again to FIG. 32, multiple piercers 150 are installed in bottom substrate 3110 of droplet actuator 3100. More details of piercers 150 with respect to dispensing system 3120 are shown and described with reference to FIG. 34.

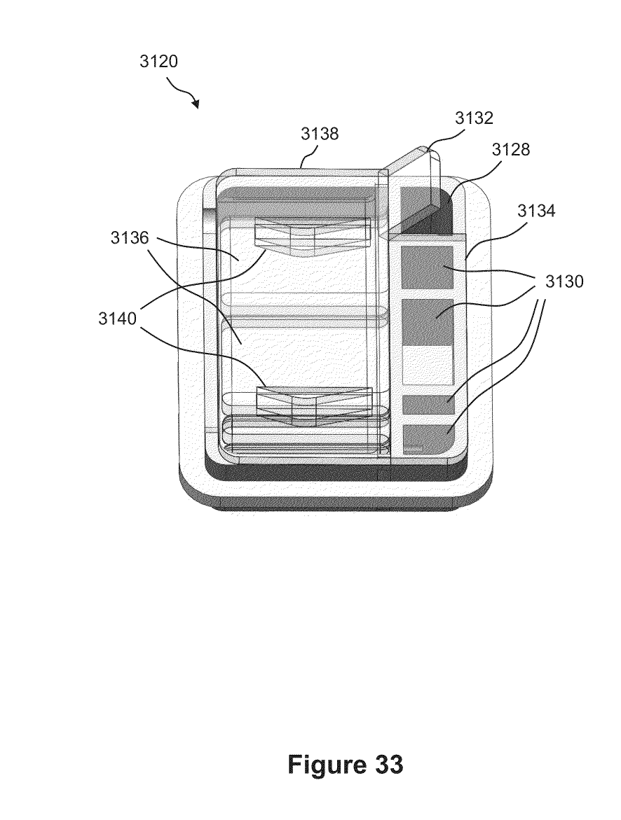

Referring now to FIG. 33, a top view of dispensing system 3120 is provided. This view of dispensing system 3120 shows that hinged cover 3132 is dedicated to reservoir 3128 that holds, for example, sample fluid, while cover 3134 is common to the four reservoirs 3130 that hold, for example, liquid reagents. FIG. 33 also shows the two dispensing levers 3140 in relation to bladders 3136. Again, dispensing levers 3140 and bladders 3136 are used for pumping liquid out of reservoir 3128 and reservoirs 3130.

Referring now to FIG. 34, a bottom view of dispensing system 3120 is provided. This view of dispensing system 3120 shows that the outlets of reservoir 3128 and each of the reservoirs 3130 has a seal 3144 that remains intact until ready for use. Additionally, the outlet of filler fluid reservoir 3148 has a seal 3146 that remains intact until ready for use. Seals 3144 and seal 3146 are, for example, foil seals or cellophane seals that can be ruptured using the piercers 150 that are installed in bottom substrate 3110 of droplet actuator 3100. For example, FIG. 34 shows the position of piercers 150 in relation to seals 3144 of reservoir 3128 and reservoirs 3130 and seal 3146 of filler fluid reservoir 3148 when dispensing system 3120 is coupled to droplet actuator 3100.

Referring to FIGS. 31 through 34, dispensing system 3120 and any rigid components thereof can be formed, for example, of molded plastic. However, because the one or more bladders 3136 must be flexible, bladders 3136 can be formed, for example, of thermoformed polyethylene.

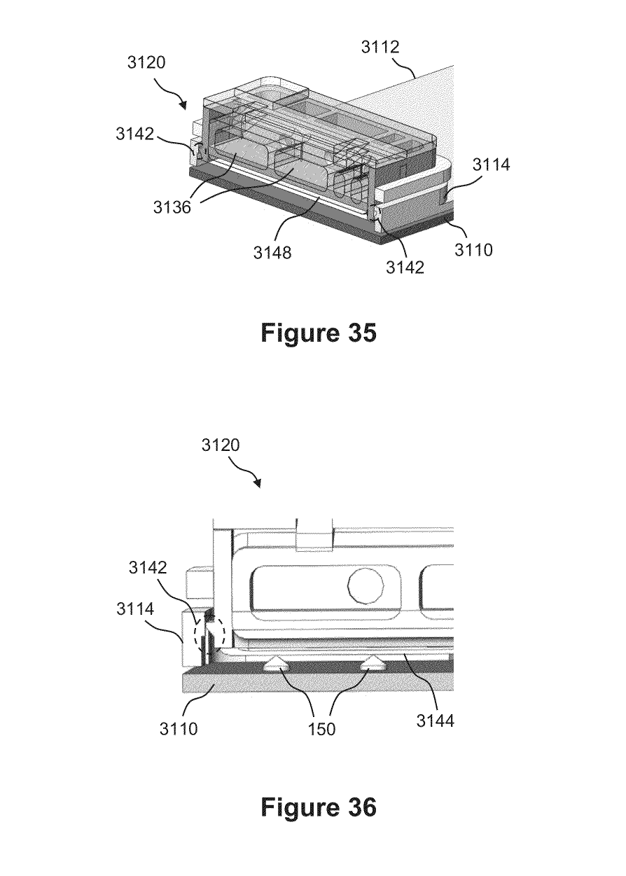

Referring now to FIGS. 35, 36, 37, and 38, various views of dispensing system 3120 are provided that show a method of using dispensing system 3120 to dispense liquids into the droplet operations gap of droplet actuator 3100. The method assumes that (1) filler fluid reservoir 3148 of dispensing system 3120 is preloaded with filler fluid and sealed with seal 3146, (2) reservoirs 3130 are preloaded with reagents and sealed with seals 3144, (3) reservoir 3128 is empty but sealed with a seal 3144, and (4) dispensing system 3120 is not yet coupled to droplet actuator 3100. The method of using dispensing system 3120 includes the following steps.

In a first step and referring again to FIG. 31, a user opens hinged cover 3132 and loads reservoir 3128 with sample fluid. Then user closes hinged cover 3132, thereby sealing the sample fluid inside of reservoir 3128.

In another step and referring now to FIGS. 35 and 36, a user snaps dispensing system 3120 into place atop droplet actuator 3100. Namely, both dispensing system 3120 and droplet actuator 3100 include locking features 3142 for snap-fitting body 3122 of dispensing system 3120 to mounting flange 3114 of droplet actuator 3100. In so doing, piercers 150 in bottom substrate 3110 come into contact with and rupture seals 3144 of reservoir 3128 and reservoirs 3130 and seal 3146 of filler fluid reservoir 3148.

In another step and referring now to FIG. 37, filler fluid (not shown) flows by gravity out of filler fluid reservoir 3148 through the pierced seal 3146 and into the droplet operations gap of droplet actuator 3100.

In another step and referring now to FIG. 38, the user pushes down on the dispensing levers 3140, which crushes bladders 3136 and pumps liquid out of reservoir 3128 and reservoirs 3130 through the pierced seals 3144 and into the droplet operations gap of droplet actuator 3100.

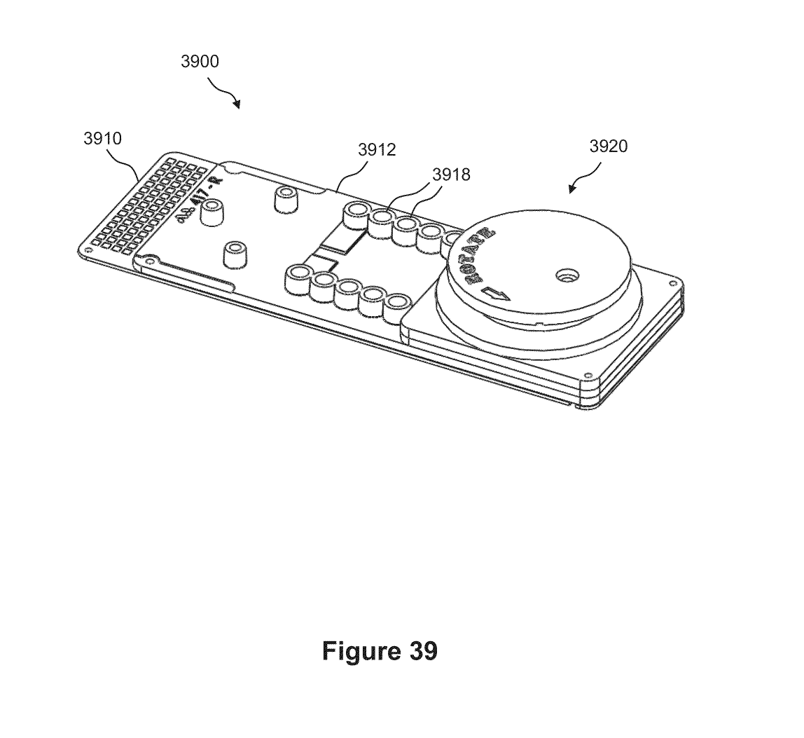

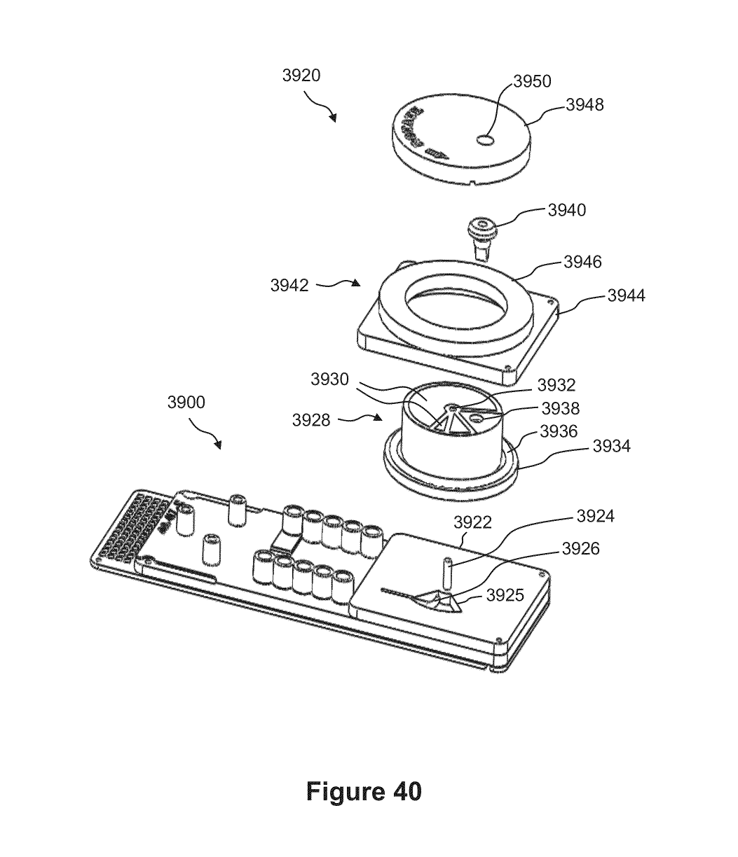

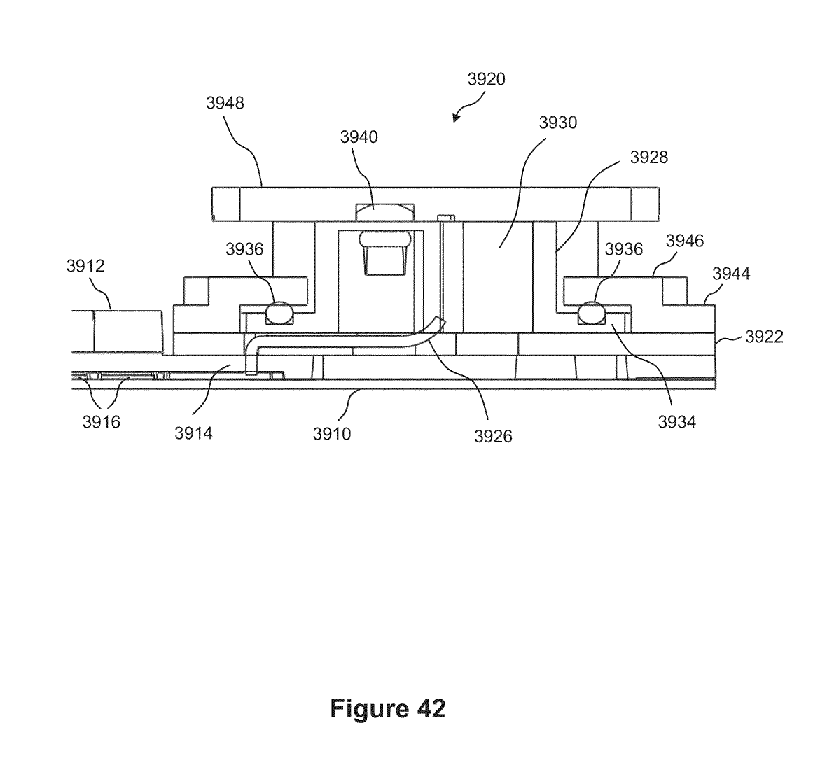

FIGS. 39 through 42 illustrate various views of a rotary dispensing system 3920 in combination with a droplet actuator 3900. Referring now to FIG. 39, an isometric view of droplet actuator 3900 to which rotary dispensing system 3920 is mechanically and fluidly coupled is provided. Droplet actuator 3900 includes a bottom substrate 3910 and a top substrate 3912 that are separated by a droplet operations gap 3914 (see FIG. 42) that contains filler fluid (not shown). Bottom substrate 3910 may include an arrangement of droplet operations electrodes 3916 (see FIG. 42). Top substrate 3912 includes a set of loading ports 3918 for loading fluid into on-actuator reservoirs (not shown) of droplet actuator 3900. Rotary dispensing system 3920 is mounted on top substrate 3912 of droplet actuator 3900, more details of which are shown and described with reference to FIGS. 40, 41, and 42.

Referring now to FIG. 40, an exploded view of droplet actuator 3900 and rotary dispensing system 3920 is provided in which more details of rotary dispensing system 3920 are shown. Rotary dispensing system 3920 includes a base plate 3922 that is mounted to or otherwise integrated into top substrate 3912 of droplet actuator 3900. A spindle 3924 protrudes from base plate 3922, which provides the axis of rotation of a reservoir module 3928 of rotary dispensing system 3920. Base plate 3922 further includes an opening 3925 through with a piercer 3926 protrudes.

Reservoir module 3928 is, for example, a cylinder-shaped module that is partitioned into multiple compartments, whereas the multiple compartments serve as reservoirs 3930. Each of the reservoirs 3930 holds a volume of liquid, such as sample fluid, liquid reagents, or filler fluid. A seal (not shown) is provided on the outlet-side of reservoirs 3930, reservoirs 3930 are then filled with liquid. In one example, the inlet-side of reservoirs 3930 is left open. In another example, the inlet-side of reservoirs 3930 is sealed. The seals (not shown) are, for example, foil seals or cellophane seals. In particular, the seal at the outlet-side of reservoirs 3930 is the type of seal that can be ruptured using piercer 3926.

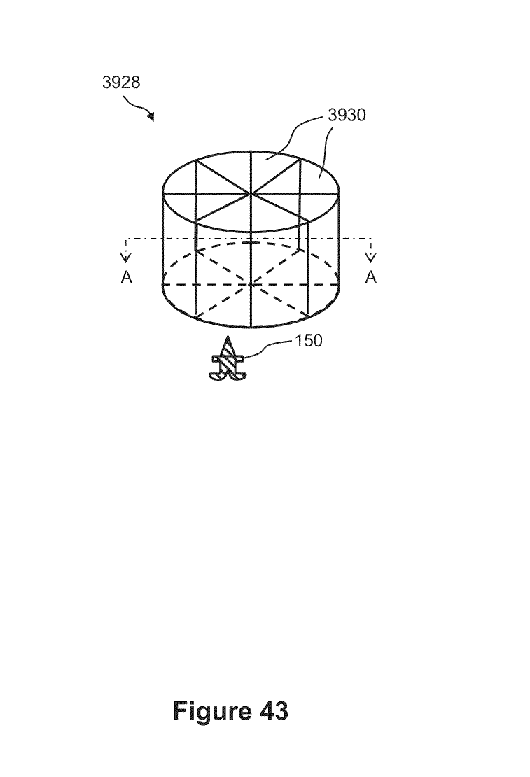

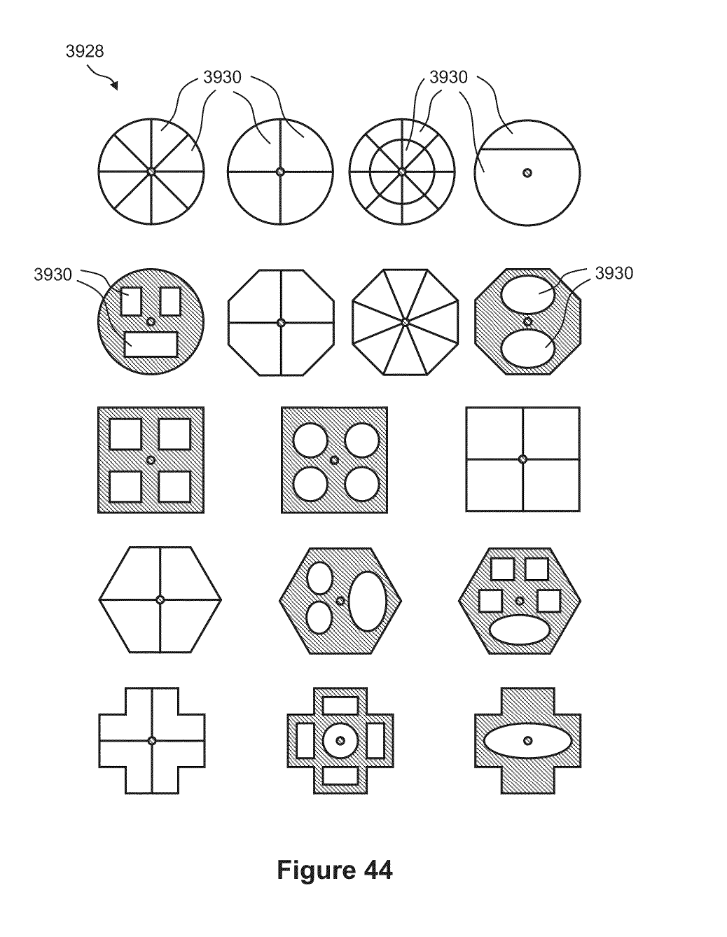

The size and/or shape of the individual reservoirs 3930 in reservoir module 3928 can be substantially the same or can vary from one to another. Additionally, the overall shape of reservoir module 3928 can vary. More details of other examples of reservoir modules 3928 and reservoirs 3930 are shown and described with reference to FIGS. 43 and 44.

Reservoir module 3928 includes a center hole 3932 that is sized to fit over spindle 3924 of base plate 3922. A lip 3934 is provided at the base of reservoir module 3928. An O-ring 3936 sits atop lip 3934. Additionally, reservoir module 3928 includes an opening or hole 3938 into which a duckbill valve 3940 is installed.

Rotary dispensing system 3920 further includes a retaining cap 3942 for securing reservoir module 3928 to base plate 3922. Retaining cap 3942 includes a base plate 3944 that has a circular opening through which reservoir module 3928 is fitted. Retaining cap 3942 also includes a ring feature 3946 around the opening in base plate 3944. The footprint of base plate 3944 is substantially the same as the footprint of base plate 3922. Rotary dispensing system 3920 further includes a handle or knob 3948 that is fitted onto retaining cap 3942. When assembled, an opening 3850 in handle or knob 3948 is aligned with and mechanically coupled to duckbill valve 3940. Except for the seals (not shown), the components of rotary dispensing system 3920 can be formed, for example, or molded plastic.

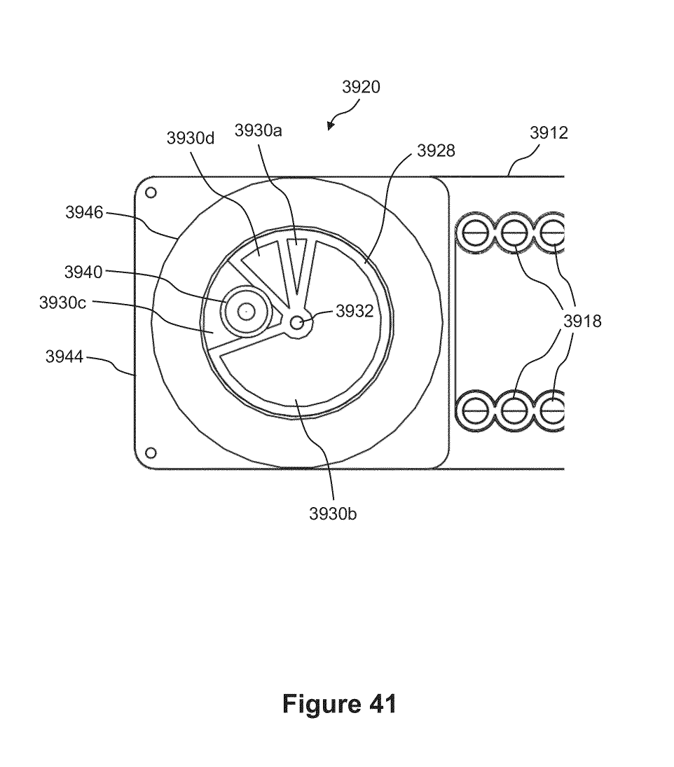

Referring now to FIGS. 40, 41, and 42, the process of assembling rotary dispensing system 3920 includes installing duckbill valve 3940 into opening or hole 3938 of reservoir module 3928. Then, sliding center hole 3932 of reservoir module 3928 over spindle 3924 of base plate 3922. In this way, reservoir module 3928 is rotatably mounted atop base plate 3922. When installing reservoir module 3928 on base plate 3922, reservoir module 3928 must be in a “park” position to avoid rupturing its seal and releasing fluid. An example of the “park” position is shown in FIG. 41, which shows a top down view of rotary dispensing system 3920 absent retaining cap 3942 so that reservoir module 3928 is visible. In this example, reservoir module 3928 includes four reservoirs 3930 (e.g., reservoirs 3930a, 3930b, 3930c, and 3930d) that are different sizes. In one example, reservoir 3930a is empty and provides the “park” position, meaning that when reservoir 3930a is aligned with piercer 3926 no liquid is dispensed from rotary dispensing system 3920. Whereas reservoir 3930b holds, for example, 2.5 ml of filler fluid; reservoir 3930c holds, for example, 600 μl of lysis or sample fluid; and reservoir 3930d holds, for example, 300 μl of binding buffer.

Once reservoir module 3928 is on spindle 3924 of base plate 3922 (in the “park” position), retaining cap 3942 is fitted over reservoir module 3928 and base plate 3944 is secured to base plate 3922. For example, base plate 3944 can be snap-fitted to base plate 3922 or fastened to base plate 3922 using screws or adhesive. In so doing, the surface of ring feature 3946 of retaining cap 3942 is fitted snuggly against O-ring 3936 that is atop lip 3934 at the base of reservoir module 3928, which creates a seal between reservoir module 3928 and retaining cap 3942. Then, handle or knob 3948 is, for example, snap-fitted to the top of reservoir module 3928. Features in handle or knob 3948 align with and mechanically secure to the top of duckbill valve 3940 in reservoir module 3928, as shown in FIG. 42, which is a cross-sectional view of rotary dispensing system 3920. Because of the mechanical coupling between handle or knob 3948 and duckbill valve 3940 in reservoir module 3928, when the user grasps and rotates handle or knob 3948, reservoir module 3928 also rotates. In particular, reservoir module 3928 rotates with respect to opening 3925 in base plate 3922 and piercer 3926.

Continuing the example and referring now to FIG. 41, reservoir module 3928 is in the “park” position, meaning that reservoir 3930a is aligned with opening 3925 in base plate 3922 and piercer 3926. Then, to dispense the filler fluid from reservoir 3930b, the user grasps handle or knob 3948 and rotates reservoir module 3928 one position counterclockwise (see FIG. 41). In so doing, reservoir 3930b is aligned with opening 3925 in base plate 3922 and piercer 3926 and its seal is ruptured, thereby releasing the filler fluid into droplet operations gap 3914 of droplet actuator 3900. Then, to dispense the sample fluid from reservoir 3930c, the user grasps handle or knob 3948 and rotates reservoir module 3928 one position counterclockwise (see FIG. 41). In so doing, reservoir 3930c is aligned with opening 3925 in base plate 3922 and piercer 3926 and its seal is ruptured, thereby releasing the sample fluid into droplet operations gap 3914 of droplet actuator 3900. Then, to dispense the binding buffer from reservoir 3930d, the user grasps handle or knob 3948 and rotates reservoir module 3928 one position counterclockwise (see FIG. 41). In so doing, reservoir 3930d is aligned with opening 3925 in base plate 3922 and piercer 3926 and its seal is ruptured, thereby releasing the binding buffer into droplet operations gap 3914 of droplet actuator 3900. According to aspects of an embodiment, duckbill valve 3940 bailout sample entry. According to further aspects of embodiments, duckbill valve 3940 may prevent at least some cartridge contents from leaking outside the cartridge.

FIG. 43 illustrates an isometric view (not to scale) of one example configuration of reservoir module 3928, which is the dispenser portion of rotary dispensing system 3920 of FIGS. 39 through 42. In this example, reservoir module 3928 is cylinder-shaped. Reservoir module 3928 has a certain diameter and height. In this example, reservoir module 3928 has eight substantially equal sized pie-shaped reservoirs 3930.

FIG. 44 illustrates cross-sectional views (not to scale) of other example configurations of reservoir module 3928, which is the dispenser portion of rotary dispensing system 3920. The examples shown in FIG. 44 are reservoir module 3928 taken along line AA of FIG. 43. These examples show that the cross-section of reservoir module 3928 can be any shape, such as, but not limited to, circular, oval, hexagonal, octagonal, square, rectangular, cross-shaped, and the like. Further, reservoir module 3928 can include any number of reservoirs 3930. Further, the cross-section of any reservoir 3930 can be any shape, such as, but not limited to, circular, oval, hexagonal, octagonal, square, rectangular, cross-shaped, and the like. Further, the shapes of reservoirs 3930 within the same reservoir module 3928 can be the same or different. Further, the layout of reservoirs 3930 within any reservoir module 3928 can be symmetrical or nonsymmetrical. Further, any reservoir module 3928 can include a dedicated “park” position-reservoir 3930 or not.

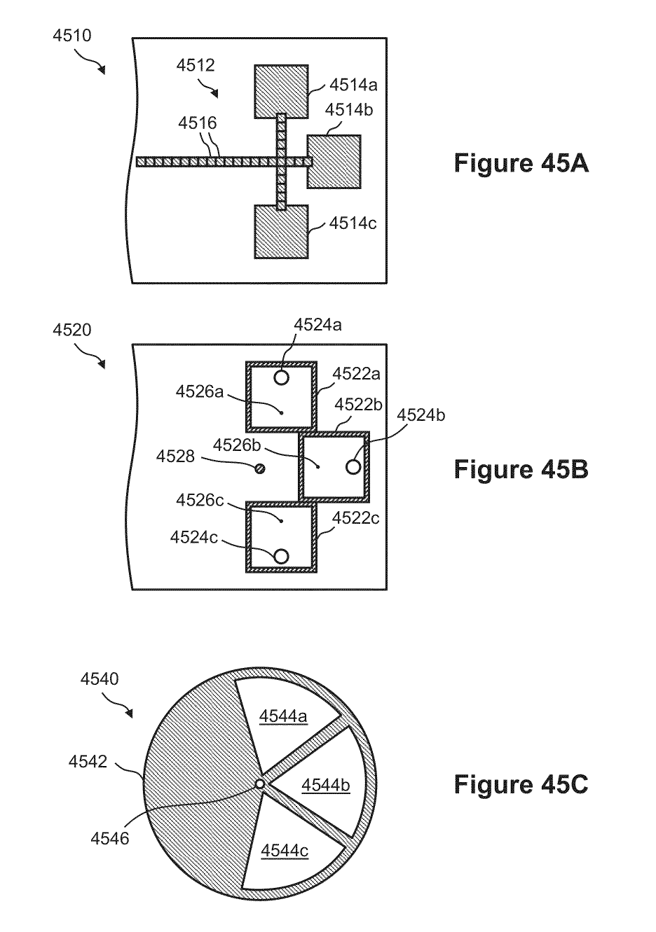

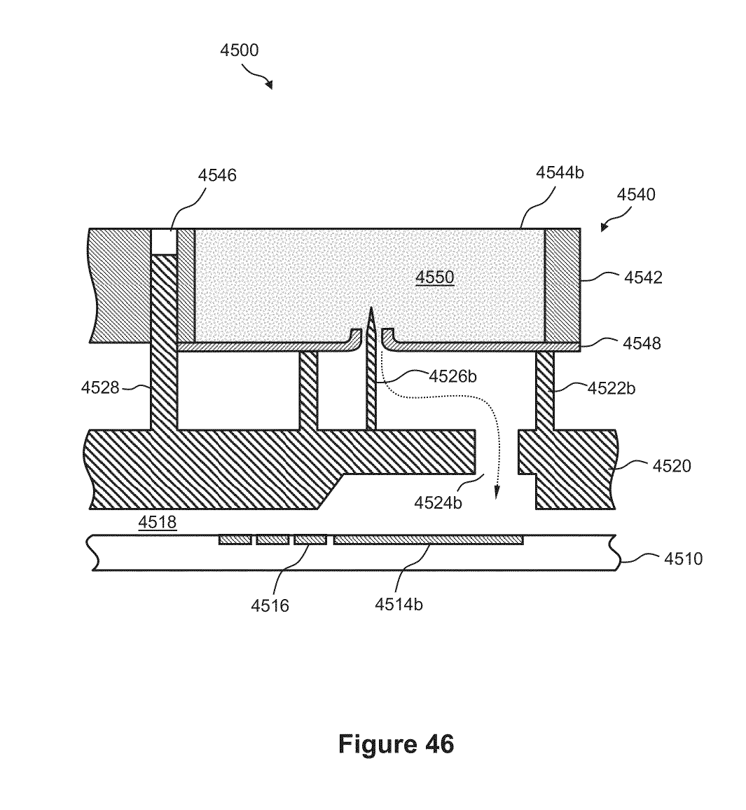

FIGS. 45A, 45B, and 45C illustrate top down views (not to scale) of a bottom substrate 4510, a top substrate 4520, and a rotary dispensing module 4540, respectively, that when assembled form a droplet actuator 4500 that is shown in FIG. 46. Namely, FIG. 46 illustrates a cross-sectional view (not to scale) of a portion of droplet actuator 4500 that includes rotary dispensing module 4540.

Referring now to FIGS. 45A, 45B, and 45C and FIG. 46, droplet actuator 4500 includes bottom substrate 4510 and top substrate 4520 that are separated by a droplet operations gap 4518. Bottom substrate 4510 includes an electrode arrangement 4512. Electrode arrangement 4512 includes, for example, three reservoir electrodes 4514 (e.g., reservoir electrodes 4514a, 4514b, and 4514c) that are fluidly connected via an arrangement of droplet operations electrodes 4516 (e.g., electrowetting electrodes). Droplet operations are conducted atop droplet operations electrodes 4516 on a droplet operations surface.

Top substrate 4520 includes, for example, three loading ports 4522 (e.g., loading ports 4522a, 4522b, and 4522c). The locations of loading ports 4522a, 4522b, and 4522c substantially correspond to the locations of reservoir electrodes 4514a, 4514b, and 4514c, respectively. Loading ports 4522a, 4522b, and 4522c include outlets 4524a, 4524b, and 4524c, respectively. Additionally, a piercer 4526 is integrated into top substrate 4520 inside of each of the loading ports 4522. For example, loading ports 4522a, 4522b, and 4522c include piercers 4526a, 4526b, and 4526c, respectively. Each piercer 4526 is, for example, a pointed spike, as shown in FIG. 46. Additionally, a spindle 4528 protrudes from top substrate 4520, which provides the axis of rotation of rotary dispensing module 4540.

Rotary dispensing module 4540 includes, for example, a body 4542 that is, for example, cylinder-shaped. Body 4542 is partitioned into, for example, three compartments, thereby forming three reservoirs 4544 (e.g., reservoirs 4544a, 4544b, and 4544c). Rotary dispensing module 4540 includes a center hole 4546 that is sized to fit over spindle 4528 of top substrate 4520. When rotary dispensing module 4540 is installed on spindle 4528 of top substrate 4520, reservoirs 4544a, 4544b, and 4544c substantially align with loading ports 4522a, 4522b, and 4522c, respectively, and with piercers 4526a, 4526b, and 4526c, respectively. Additionally, the outlet-side of rotary dispensing module 4540 includes a seal 4548 for sealing the outlets of reservoirs 4544a, 4544b, and 4544c. That is, one continuous seal 4548 can span all three reservoirs 4544. Seal 4548 is, for example, a foil or cellophane seal. Reservoirs 4544a, 4544b, and 4544c hold liquid 4550. Liquid 4550 is, for example, sample fluid, liquid reagent, or filler fluid. Further, reservoirs 4544a, 4544b, and 4544c can be loaded with the same or different types of liquid 4550. For example, reservoir 4544a can be loaded with sample fluid, while reservoirs 4544b and 4544c are loaded with liquid reagent.

In the example shown in FIGS. 45A, 45B, and 45C and FIG. 46, droplet actuator 4500 and rotary dispensing module 4540 are designed to support three loading ports 4522. However, this is exemplary only. Droplet actuator 4500 and rotary dispensing module 4540 can be designed to support any number of loading ports 4522. Further, the footprint of rotary dispensing module 4540 is not limited to circular, as only a slight amount of rotation is needed to operate. In other examples, the footprint of rotary dispensing module 4540 can be hexagonal, octagonal, square, or cross-shaped as long as reservoirs 4544 (which can be any shape) substantially align with loading ports 4522 in top substrate 4520.

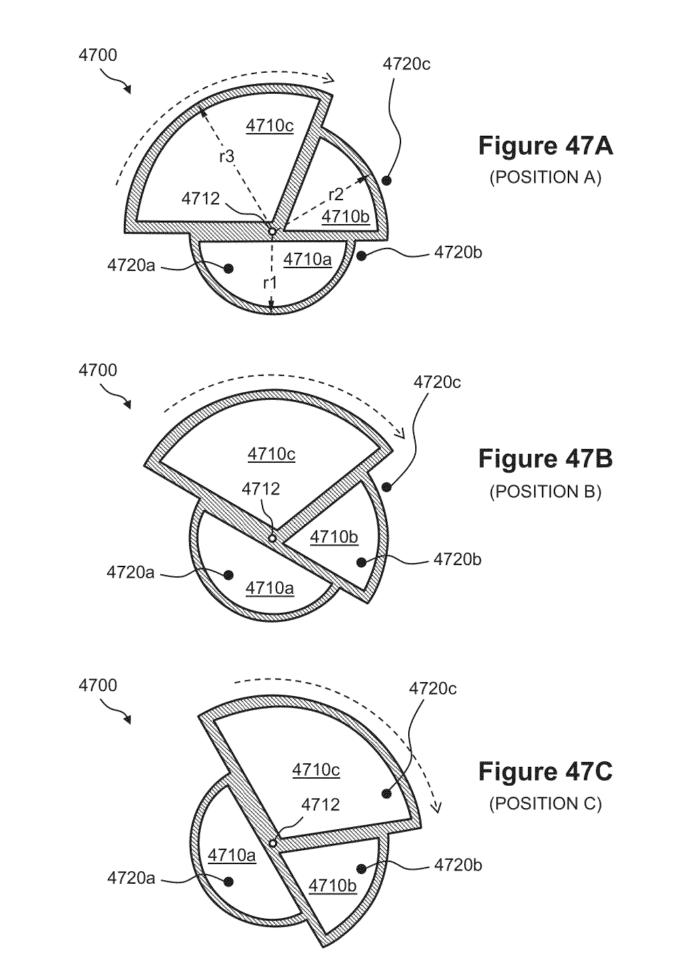

Referring now to FIG. 46, which is a cross-sectional view of droplet actuator 4500 taken across reservoir electrode 4514b, loading port 4522b, and reservoir 4544b, the operation of rotary dispensing module 4540 is as follows. Rotary dispensing module 4540 is provided separately from droplet actuator 4500. Rotary dispensing module 4540 is sealed via seal 4548 and its reservoirs 4544 are loaded with the desired types of liquid 4550. The user visually aligns reservoirs 4544a, 4544b, and 4544c with loading ports 4522a, 4522b, and 4522c, respectively, and slides center hole 4546 of rotary dispensing module 4540 onto spindle 4528 of top substrate 4520. In so doing, rotary dispensing module 4540 comes to rest atop loading ports 4522. Because the length of piercers 4526 is greater than the height of loading ports 4522, the tips of piercers 4526a, 4526b, and 4526c puncture or rupture seal 4548 at each of the loading ports 4522a, 4522b, and 4522c, respectively. Then, the user slightly rotates rotary dispensing module 4540 so that piercers 4526a, 4526b, and 4526c can create larger tears in seal 4548. Liquid 4550 then flows out of reservoirs 4544a, 4544b, and 4544c; through loading ports 4522a, 4522b, and 4522c, respectively; through outlets 4524a, 4524b, and 4524c, respectively, and into droplet operations gap 4518 of droplet actuator 4500.

Whereas rotary dispensing module 4540 of FIG. 45A is an example of a rotary dispensing module whose reservoirs drain simultaneously, FIGS. 47A, 47B, and 47C illustrate top down views (not to scale) of a rotary dispensing module 4700 whose reservoirs drain sequentially. Rotary dispensing module 4700 includes, for example, three reservoirs 4710 (e.g., reservoirs 4710a, 4710b, and 4710c). The three reservoirs 4710 are different sizes. Namely, the three different sized reservoirs 4710 are arranged in a common structure that rotates about a center hole 4712. Center hole 4712 provides the axis of rotation for rotary dispensing module 4700. In this example, reservoir 4710a is the smallest reservoir and reservoir 4710c is the largest reservoir. More specifically, reservoir 4710a has a radius r1 from center hole 4712, reservoir 4710b has a radius r2 from center hole 4712, and reservoir 4710d has a radius r3 from center hole 4712, where r1<r2<r3. Because r1<r2<r3, the footprint of rotary dispensing module 4700 has the appearance of three different sized lobes. Rotary dispensing module 4700 is not limited to three reservoirs 4710. This is exemplary only. Rotary dispensing module 4700 can include any number of reservoirs 4710. Additionally, the outlet-side of rotary dispensing module 4700 is sealed with, for example, a foil or cellophane seal.

When in use, rotary dispensing module 4700 is installed atop a droplet actuator (not shown), wherein the droplet actuator includes, in this example, three piercers 4720 (e.g., piercers 4720a, 4720b, and 4720c). The locations of piercers 4720a, 4720b, and 4720c substantially correspond to the locations of three loading ports (not shown) or three reservoirs (not shown) of the droplet actuator. A spindle (not shown) on which rotary dispensing module 4700 is mounted is provided with respect to piercers 4720 so that rotary dispensing module 4700 can rotate with respect to piercers 4720.

In operation and referring now to FIG. 47A, rotary dispensing module 4700 is installed in a position A with respect to piercers 4720. Namely, in position A, piercer 4720a punctures or ruptures the seal of reservoir 4710a while at the same time piercer 4720b and piercer 4720c are outside of rotary dispensing module 4700. Consequently, reservoir 4710a is drained while reservoir 4710b and reservoir 4710c are not drained.

Next and referring to FIG. 47B, once reservoir 4710a has been drained, rotary dispensing module 4700 is rotated to a position B with respect to piercers 4720. Namely, in position B, piercer 4720b punctures or ruptures the seal of reservoir 4710b while at the same time piercer 4720c is still outside of rotary dispensing module 4700. Consequently, reservoir 4710b is now drained while reservoir 4710c is still not drained.

Next and referring to FIG. 47C, once reservoir 4710a and reservoir 4710b have been drained, rotary dispensing module 4700 is rotated to a position C with respect to piercers 4720. Namely, in position C, piercer 4720c punctures or ruptures the seal of reservoir 4710c. Consequently, reservoir 4710c is now drained. At the completion of this step, all three reservoirs 4710a, 4710b, and 4710c have been drained, albeit in a sequential manner.

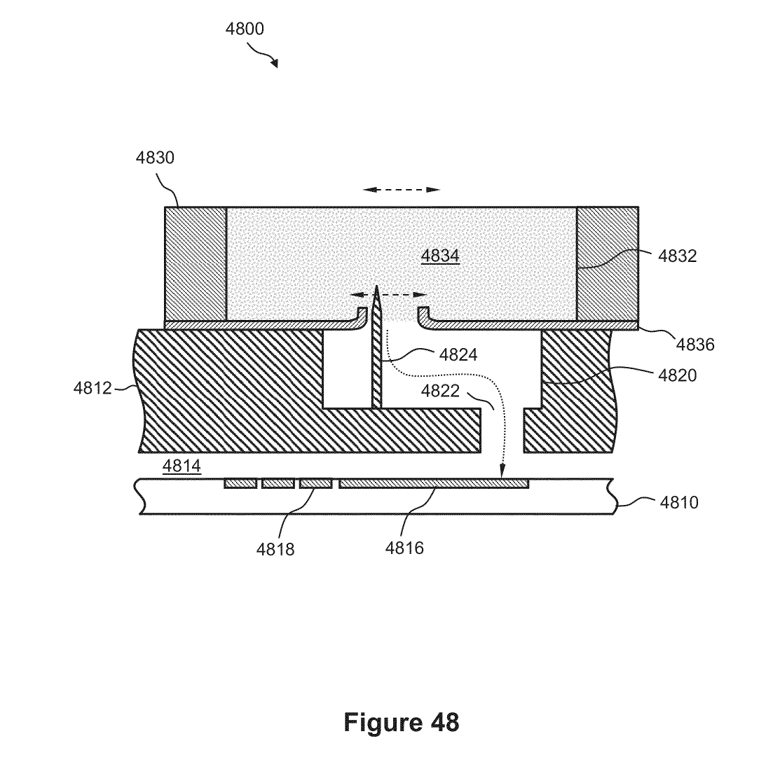

FIG. 48 illustrates a cross-sectional view (not to scale) of a portion of a droplet actuator 4800 that includes a slidable dispensing reservoir 4830. Droplet actuator 4800 includes a bottom substrate 4810 and a top substrate 4812 that are separated by a droplet operations gap 4814. Bottom substrate 4810 includes, for example, a reservoir electrode 4816 that is fluidly connected to an arrangement of droplet operations electrodes 4818 (e.g., electrowetting electrodes). Droplet operations are conducted atop droplet operations electrodes 4818 on a droplet operations surface.

A loading port 4820 is integrated into top substrate 4812. Loading port 4820 has an outlet 4822 facing droplet operations gap 4814. A piercer 4824 protrudes from top substrate 4812 and is inside of loading port 4820. The length of piercer 4824 is greater than the height of loading port 4820. Therefore, the pointed tip of piercer 4824 extends loading port 4820 as shown.

Slidable dispensing reservoir 4830 includes a reservoir 4832 for holding a quantity of liquid 4834. Liquid 4834 is, for example, sample fluid, liquid reagent, or filler fluid. Additionally, the outlet-side of slidable dispensing reservoir 4830 includes a seal 4836 for sealing the outlet of reservoir 4832. Seal 4836 is, for example, a foil or cellophane seal.

In operation, slidable dispensing reservoir 4830 is provided separately from droplet actuator 4800. Slidable dispensing reservoir 4830 is sealed via seal 4836 and reservoir 4832 is loaded with liquid 4834. The user visually aligns reservoir 4832 with loading port 4820 and a places slidable dispensing reservoir 4830 atop top substrate 4520. In so doing, slidable dispensing reservoir 4830 comes to rest against loading port 4820. Because the length of piercer 4824 is greater than the height of loading port 4820, the tip of piercer 4824 punctures or ruptures seal 4836 of reservoir 4832. Then, the user slightly slides slidable dispensing reservoir 4830 so that piercer 4824 can create a larger tear in seal 4836. Liquid 4834 then flows out of reservoir 4832, through loading port 4820, through outlet 4822, and into droplet operations gap 4814 of droplet actuator 4800.

Referring now to FIGS. 1 through 48, any combination of any types of piercers, dispensers, and seals described herein can be installed in or otherwise used with a droplet actuator.

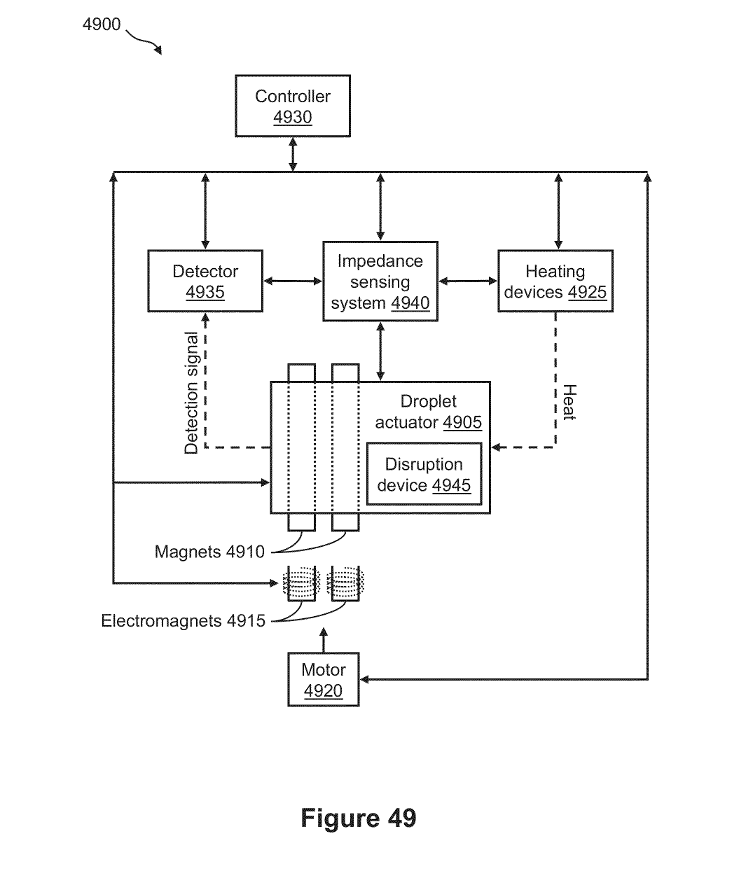

FIG. 49 illustrates a functional block diagram of an example of a microfluidics system 4900 that includes a droplet actuator 4905. Digital microfluidic technology conducts droplet operations on discrete droplets in a droplet actuator, such as droplet actuator 4905, by electrical control of their surface tension (electrowetting). The droplets may be sandwiched between two substrates of droplet actuator 4905, a bottom substrate and a top substrate separated by a droplet operations gap. The bottom substrate may include an arrangement of electrically addressable electrodes. The top substrate may include a reference electrode plane made, for example, from conductive ink or indium tin oxide (ITO). The bottom substrate and the top substrate may be coated with a hydrophobic material. Droplet operations are conducted in the droplet operations gap. The space around the droplets (i.e., the gap between bottom and top substrates) may be filled with an immiscible inert fluid, such as silicone oil, to prevent evaporation of the droplets and to facilitate their transport within the device. Other droplet operations may be effected by varying the patterns of voltage activation; examples include merging, splitting, mixing, and dispensing of droplets.

Droplet actuator 4905 may be designed to fit onto an instrument deck (not shown) of microfluidics system 4900. The instrument deck may hold droplet actuator 4905 and house other droplet actuator features, such as, but not limited to, one or more magnets and one or more heating devices. For example, the instrument deck may house one or more magnets 4910, which may be permanent magnets. Optionally, the instrument deck may house one or more electromagnets 4915. Magnets 4910 and/or electromagnets 4915 are positioned in relation to droplet actuator 4905 for immobilization of magnetically responsive beads. Optionally, the positions of magnets 4910 and/or electromagnets 4915 may be controlled by a motor 4920. Additionally, the instrument deck may house one or more heating devices 4925 for controlling the temperature within, for example, certain reaction and/or washing zones of droplet actuator 4905. In one example, heating devices 4925 may be heater bars that are positioned in relation to droplet actuator 4905 for providing thermal control thereof.

A controller 4930 of microfluidics system 4900 is electrically coupled to various hardware components of the invention, such as droplet actuator 4905, electromagnets 4915, motor 4920, and heating devices 4925, as well as to a detector 4935, an impedance sensing system 4940, and any other input and/or output devices (not shown). Controller 4930 controls the overall operation of microfluidics system 4900. Controller 4930 may, for example, be a general purpose computer, special purpose computer, personal computer, or other programmable data processing apparatus. Controller 4930 serves to provide processing capabilities, such as storing, interpreting, and/or executing software instructions, as well as controlling the overall operation of the system. Controller 4930 may be configured and programmed to control data and/or power aspects of these devices. For example, in one aspect, with respect to droplet actuator 4905, controller 4930 controls droplet manipulation by activating/deactivating electrodes.

In one example, detector 4935 may be an imaging system that is positioned in relation to droplet actuator 4905. In one example, the imaging system may include one or more light-emitting diodes (LEDs) (i.e., an illumination source) and a digital image capture device, such as a charge-coupled device (CCD) camera.

Impedance sensing system 4940 may be any circuitry for detecting impedance at a specific electrode of droplet actuator 4905. In one example, impedance sensing system 4940 may be an impedance spectrometer. Impedance sensing system 4940 may be used to monitor the capacitive loading of any electrode, such as any droplet operations electrode, with or without a droplet thereon. For examples of suitable capacitance detection techniques, see Sturmer et al., International Patent Publication No. WO/2008/101194, entitled “Capacitance Detection in a Droplet Actuator,” published on Aug. 21, 2008; and Kale et al., International Patent Publication No. WO/2002/080822, entitled “System and Method for Dispensing Liquids,” published on Oct. 17, 2002; the entire disclosures of which are incorporated herein by reference.

Droplet actuator 4905 may include disruption device 4945. Disruption device 4945 may include any device that promotes disruption (lysis) of materials, such as tissues, cells and spores in a droplet actuator. Disruption device 4945 may, for example, be a sonication mechanism, a heating mechanism, a mechanical shearing mechanism, a bead beating mechanism, physical features incorporated into the droplet actuator 4905, an electric field generating mechanism, a thermal cycling mechanism, and any combinations thereof. Disruption device 4945 may be controlled by controller 4930.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

What is claimed is:

1. A microfluidic system comprising:
a droplet actuator including an interior cavity and a series of electrodes arranged along the interior cavity for forming a droplet-operation path therethrough, the droplet actuator having a module-engaging side including an opening that is in flow communication with the interior cavity;
a reservoir module configured to be coupled to the droplet actuator, the reservoir module including a plurality of liquid compartments having respective outlets and at least one seal positioned along the outlets to retain liquid within the liquid compartments, wherein the reservoir module is movable along the module-engaging side of the droplet actuator to position the outlets relative to the opening; and
a piercer configured to penetrate the seal thereby permitting the liquid within the corresponding liquid compartment to flow into the opening.

2. The microfluidic system of claim 1, wherein the liquid compartments move in a loading direction when the reservoir module is moved along the module-engaging side, the piercer moving, relative to the reservoir module, in a piercing direction that is transverse to the loading direction when penetrating the seal.

3. The microfluidic system of claim 1, wherein the reservoir module is configured to rotate about an axis of rotation when moved along the module-engaging side of the droplet actuator.

4. The microfluidic system of claim 3, wherein the liquid compartments include at least three liquid compartments that are positioned at different circumferential locations with respect to the axis of rotation, at least two of the liquid compartments having different volumes for holding the liquids.

5. The microfluidic system of claim 1, wherein the reservoir module is configured to slide laterally along the module-engaging side of the droplet actuator.

6. The microfluidic system of claim 1, wherein the piercer includes a plurality of piercers and the opening includes a plurality of openings.

7. The microfluidic system of claim 6, wherein the reservoir module is configured to have different first, second, and third positions with respect to the plurality of piercers and wherein the liquid compartments include at least a filler fluid compartment, multiple reagent compartments, and a sample compartment, the filler fluid compartment being pierced when the reservoir module is in the first position, the multiple reagent compartments being pierced when in the second position, and the sample compartment being pierced when in the third position.

8. The microfluidic system of claim 7, wherein the filler fluid compartment includes a non-polar liquid and the reagent compartments and the sample compartments include polar liquids.

9. The microfluidic system of claim 6, wherein the reservoir module is configured to have different first and second positions with respect to the plurality of piercers and wherein a first set of one or more liquid compartments is pierced when the reservoir module is in the first position and a second set of one or more liquid compartments is pierced when in the second position.

10. The microfluidic system of claim 9, wherein the first set of one or more compartments contains filler fluid.

11. The microfluidic system of claim 9, wherein the second set of one or more compartments contains reagents and/or samples.

12. The microfluidic system of claim 6, wherein the electrodes include a plurality of reservoir electrodes having different locations along the interior cavity, each of the openings being associated with a respective reservoir electrode of the plurality of reservoir electrodes such that the liquid that flows through the opening gathers along the respective reservoir electrode in the interior cavity.

13. The microfluidic system of claim 1, wherein the piercer is secured to the droplet actuator such that the reservoir module moves relative to the piercer when the reservoir module is moved along the module-engaging side.

14. The microfluidic system of claim 1, wherein the piercer is secured to the reservoir module such that the piercer moves with the reservoir module.

15. The microfluidic system of claim 1, wherein the piercer includes a fluid channel extending therethrough, the fluid channel having an inlet at an end of the piercer.

16. The microfluidic system of claim 1, further comprising a controller having circuitry configured to selectively activate the electrodes for conducting droplet operations along the substrate surface.

17. The microfluidic system of claim 1, wherein the droplet actuator includes first and second substrates having the interior cavity therebetween in which at least one of the first and second substrates includes the electrodes.

18. The microfluidic system of claim 1, wherein the seal comprises at least one of foil, cellophane, or versapor oleophobic membrane.

19. The microfluidic system of claim 1, further comprising the liquids within the liquid compartments.

20. A method of dispensing liquid comprising:
providing a microfluidic device having an interior cavity and a module-engaging side, the module-engaging side having an opening that is in fluid communication with the interior cavity;
positioning a reservoir module along the module-engaging side of the microfluidic device, the reservoir module including first and second liquid compartments having respective outlets and at least one seal positioned along the outlets to retain liquid within the first and second liquid compartments;
piercing the seal along the outlet of the first liquid compartment to permit the liquid from the first liquid compartment to flow through the opening of the microfluidic device;
sliding the reservoir module along the module-engaging side of the microfluidic device; and
piercing the seal along the outlet of the second liquid compartment to permit the liquid from the second liquid compartment to flow through the opening of the microfluidic device.

21. The method of claim 20, wherein sliding the reservoir module along the module-engaging side includes moving the reservoir module in a loading direction and wherein piercing the seal along the outlet of the first liquid compartment includes relatively moving a piercer in a piercing direction into the seal, the piercing direction being transverse to the loading direction.

22. The method of claim 20, wherein piercing the seal along the outlet of the first liquid compartment and piercing the seal along the outlet of the second liquid compartment includes using a common piercer.

23. The method of claim 22, wherein the common piercer has a fixed position relative to the microfluidic device.

24. The method of claim 20, wherein piercing the seal along the outlet of the first liquid compartment and piercing the seal along the outlet of the second liquid compartment includes using different piercers.

25. The method of claim 24, wherein the reservoir module further comprises a third liquid compartment having a respective outlet and wherein piercing the seal along the outlet of the second liquid compartment includes piercing the seal along the outlet of the third liquid compartment.

26. The method of claim 25, wherein the reservoir module further comprises a fourth liquid compartment having a respective outlet with the seal positioned therealong, the method further comprising, after the first, second, and third liquid compartments are pierced, sliding the reservoir module along the module-engaging side of the microfluidic device and piercing the seal along the outlet of the fourth liquid compartment.

27. The method of claim 25, wherein the first liquid compartment includes a non-polar liquid and the second and third liquid compartments include polar liquids.

28. The method of claim 20, wherein sliding the reservoir module includes rotating the reservoir module about an axis of rotation.

29. The method of claim 28, further comprising a third liquid compartment, wherein the first, second, and third liquid compartments are positioned at different circumferential locations with respect to the axis of rotation, at least two of the first, second, and third compartments having different volumes for retaining the liquids.

30. The method of claim 20, wherein sliding the reservoir module includes sliding the reservoir module laterally along the module-engaging side.

31. The method of claim 20, wherein the reservoir module includes a third liquid compartment having liquid therein, the method further comprising piercing the seal along the outlet of the third liquid compartment to permit the liquid from the third liquid compartment to flow through the opening of the microfluidic device.

32. The method of claim 20, wherein the microfluidic device includes a droplet actuator having the interior cavity and the opening, the droplet actuator including a series of electrodes arranged proximate to a substrate surface of the interior cavity, the electrodes forming a droplet-operation path along the substrate surface for conducting droplet operations.

33. A reservoir module comprising:
a module body having a mounting side configured to interface with a microfluidic device, the module body including a plurality of liquid compartments that have corresponding liquids preloaded therein; and
at least one seal extending along the mounting side and covering respective outlets of the liquid compartments, the liquids being separately stored within the corresponding liquid compartments, wherein the seal is configured to be at least one of penetrated or ruptured to permit the liquids to exit the corresponding liquid compartments through the seal and the mounting side.

34. The reservoir module of claim 33, wherein the seal includes a plurality of seals that extend along the respective outlets of the liquid compartments, at least some of the seals coinciding with a common plane.

35. The reservoir module of claim 34, wherein the module body is configured to rotate about an axis of rotation that is orthogonal to the common plane, the liquid compartments being distributed about the axis of rotation.

36. The reservoir module of claim 33, wherein the liquid compartments include a first liquid compartment having a filler fluid and a second liquid compartment having a liquid reagent.

37. The reservoir module of claim 33, further comprising a piercer coupled to the module body, the piercer configured to at least one of penetrate or rupture the seal.

38. A droplet actuator comprising:
an actuator housing comprising an interior cavity and a series of electrodes arranged along the interior cavity for forming a droplet-operation path therethrough, the actuator housing having a module-engaging side including an opening that is in flow communication with the interior cavity; and
a piercing mechanism having a body that is coupled to the substrate and positioned within or proximate to the opening, the body of the piercing mechanism configured to at least one of penetrate or rupture a seal of a reservoir along the module-engaging side of the substrate.

39. The droplet actuator of claim 38, further comprising a spindle that rotatably couples the actuator housing to the reservoir.

40. The droplet actuator of claim 38, wherein the body is one of a piercer, a wire, or an electric resistive coil.

41. The droplet actuator of claim 38, further comprising a controller having circuitry configured to selectively activate the electrodes for conducting droplet operations along the substrate surface.
